(19) United States
(12) Patent Application Publication
(10) Pub. No.: US 2016/0077044 A1
(43) Pub. Date: Mar. 17, 2016

(54) AMPEROMETRIC ELECTROCHEMICAL SENSORS, SENSOR SYSTEMS AND DETECTION METHODS

(71) Applicants: Gene B. Arkenberg, Columbus, OH (US); Scott L. Swartz, Columbus, OH (US); Matthew M. Seabaugh, Columbus, OH (US); Lora B. Thrun, Grove City, OH (US)

(72) Inventors: Gene B. Arkenberg, Columbus, OH (US); Scott L. Swartz, Columbus, OH (US); Matthew M. Seabaugh, Columbus, OH (US); Lora B. Thrun, Grove City, OH (US)

(21) Appl. No.: 14/854,016

(22) Filed: Sep. 14, 2015

Related U.S. Application Data
(60) Provisional application No. 62/049,977, filed on Sep. 12, 2014.

(51) Int. Cl. G01N 27/407

(52) U.S. Cl. CPC G01N 27/4074; G01N 27/4075

(57) ABSTRACT

An amperometric electrochemical sensor for measuring the concentrations of two or more target gas species in a gas sample or gas stream, wherein the sensor includes first and second electrochemical cells having respective first and second active electrodes, the electrochemical cells further including an electrolyte membrane and a counter electrode, wherein the first electrochemical cell exhibits an additive response with respect to a first and second ones of the target gas species and the second electrochemical cell exhibits a selective response to the first target gas species in the presence of the second target gas species such that the sensor is capable of measuring the respective concentrations of the first and second target gas species.

### CROSS REFERENCE TO RELATED APPLICATIONS

This application claims priority to U.S. Provisional Patent Application No. 62/049,977, filed Sep. 12, 2014, entitled Amperometric Electrochemical Sensors, Sensor Systems and Detection Methods. The entire disclosure of the foregoing provisional patent application is incorporated by reference herein.

### STATEMENT REGARDING FEDERALLY SPONSORED RESEARCH OR DEVELOPMENT

The present invention was partially made with Government support under contract DE-SC-0009258 awarded by the United States Department of Energy. The Government has certain rights in the invention.

### BACKGROUND

The increase in worldwide industrialization has generated concern regarding pollution created by combustion processes. Particularly, emissions from vehicles or other distributed sources are of concern. New environmental regulations are driving NO_{X} (a mixture of NO and NO₂ of varying ratio) emissions from diesel fueled vehicles to increasingly lower levels, with the most challenging of these being the 2010 EPA Tier 2 diesel tailpipe standards.

To meet these emission regulations, engine manufacturers have been developing new diesel after-treatment technologies, such as selective catalyst reduction (SCR) systems and lean NO_{X} traps (LNT). These technologies often require multiple NO_{X} sensors to monitor performance and satisfy on-board diagnostics requirements for tailpipe emissions. Point of generation abatement technologies also have been developed for NO_{X} along with other pollutants, but these solutions can reduce fuel efficiency if they are applied without closed loop control. Further, some of the proposed solutions themselves can be polluting if improperly controlled (e.g., selective catalytic reduction systems for NO_{X} can release ammonia into the atmosphere). Control of these abatement technologies requires compact, sensitive sensors for NO_{X}, NH₃ and other pollutants that are capable of operating in oxygen-containing exhaust streams such as exhaust streams resulting from lean-burn engine operating conditions.

A number of approaches have been described for measuring the concentrations of NO_{X} and NH₃. These include electrochemical, potentiometric, mixed potential, chemi-resistive, amperometric and impedance based methods. A good discussion of these approaches is provided in U.S. Pat. No. 8,974,657, which is incorporated by reference herein. While a variety of devices and techniques may exist for accurately detecting NO_{X} or other target gas species, it is believed that no one prior to the inventors has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings. In the drawings, like numerals represent like elements throughout the several views.

FIG. 1 is a schematic, cross-sectional view of an electrochemical sensor incorporated into a sensor system, wherein the active electrode has a full coverage current collector layer and the counter electrode is buried (located on the opposite side of the electrolyte layer).

FIG. 2 is an exploded view of a modified electrochemical sensor design that was used for some of the sensor testing described herein, wherein the sensor includes a substrate, a heater layer embedded within the substrate, an resistance temperature detector (RTD) layer on one substrate face, and multiple sequential layers on the opposite substrate face: a counter electrode layer, an electrolyte membrane layer, an active electrode layer, and a current collector layer that only covers the perimeter of the active electrode layer (i.e., has a central opening).

FIG. 3 is a schematic illustration of circuitry for use in conjunction with the sensors described herein, such as for purposes of sensor testing, wherein the ammeter functionality is provided by measuring the voltage drop across a shunt resistor (with the voltage drop proportional to the current flowing through the sensor).

FIG. 4 is a plot of nitrogen selectivity versus temperature during ammonia oxidation catalyst testing of active electrode materials of Examples 1 and 3.

FIG. 5 is a plot of NO_{X} selectivity versus temperature during ammonia oxidation catalyst testing of active electrode materials of Examples 1 and 3.

FIG. 6 is a plot that compares sensitivity at 525° C. to mixtures of NO and ammonia (NH₃) for sensors made with additive electrode material of Example 1 and the selective electrode material of Example 3, with forward (positive) bias of 200 mV applied to both sensors.

FIG. 7 is a plot that compares sensitivity at 525° C. to mixtures of NO and NO₂ for sensors made with additive electrode material of Example 1 and the selective electrode material of Example 3, with forward (positive) bias of 200 mV applied to both sensors.

FIG. 8 is a plot that compares sensitivity at 525° C. to mixtures of NO and NH₃ for sensors made with additive electrode material of Example 1 and the selective electrode material of Example 3, with forward (positive) bias of +200 mV applied to the sensor having the active electrode of Example 1 and reverse (negative) bias of −200 mV applied to the sensor having the selective electrode of Example 3.

FIG. 9 is a plot that compares sensitivity at 525° C. to mixtures of NO and NH₃ for a sensor made with the selective electrode material of Example 3, when tested with a forward (positive) bias of +400 mV bias and with a reverse (negative) bias of −400 mV bias applied to the sensor.

FIG. 10 is an exploded view of an alternative sensor system comprising two electrochemical cells, one exhibiting an additive response to two or more target gas species and the other exhibiting a selective response to at least one of the target gas species, wherein the sensor system includes a substrate, a heater layer embedded within the substrate, an RTD layer on one substrate face, and multiple sequential layers on the opposite substrate face, including: a common counter electrode layer, a common electrolyte membrane layer, and two sets of active electrode and current collector layers, with the current collector layers fully covering their respective active electrodes.

FIGS. 11A, 11B, 11C and 11D depict schematic cross-sectional views of four alternative embodiments of sensor systems comprising two electrochemical cells, one exhibiting an additive response to two or more target gas species and the other exhibiting a selective response to at least one of the target gas species. In the embodiment of FIG. 11A, the two electrochemical cells have common electrolyte and counter electrode layers. In FIG. 11B, the two electrochemical cells have separate counter-electrode layers and a common electrolyte layer. In FIG. 11C, the two electrochemical cells have a common counter-electrode layer and separate electrolyte layers. In FIG. 11D, the two electrochemical cells have separate counter-electrode layers and separate electrolyte layers.

FIG. 12 is a schematic cross-sectional view showing how the active sensing layers were configured in the surface-electrode sensors of Examples 8-15, with a circuit diagram showing how these sensors were tested.

FIG. 13 is a bar chart comparing current signals in simulated combustion exhaust atmospheres (baseline gas, baseline with 100 ppm NO, baseline with 100 ppm NO₂, and baseline with 100 ppm NH₃) for the sensor of Example 8, tested at 525° C. with an applied bias voltage of 200 mV.

FIG. 14 is a bar chart comparing current signals in simulated combustion exhaust atmospheres (baseline gas, baseline with 100 ppm NO, baseline with 100 ppm NO₂, and baseline with 100 ppm NH₃) for the sensor of Example 9, tested at 525° C. with an applied bias voltage of 200 mV.

FIG. 15 is a bar chart comparing current signals in simulated combustion exhaust atmospheres (baseline gas, baseline with 100 ppm NO, baseline with 100 ppm NO₂, and baseline with 100 ppm NH₃) for the sensor of Example 10, tested at 525° C. with an applied bias voltage of 200 mV.

FIG. 16 is a bar chart comparing current signals in simulated combustion exhaust atmospheres (baseline gas, baseline with 100 ppm NO, baseline with 100 ppm NO₂, and baseline with 100 ppm NH₃) for the sensor of Example 11, tested at 525° C. with an applied bias voltage of 200 mV.

FIG. 17A and FIG. 17B are top and cross-sectional schematic views, respectively, of yet another alternative embodiment of a sensor system comprising two electrochemical cells having a common electrolyte layer and a common counter-electrode layer located between the two active electrode layers on the same side of the electrolyte layer (also referred to as a surface electrode sensor).

FIG. 17C and FIG. 17D are top and cross-sectional schematic views, respectively, of an alternative embodiment of a surface electrode sensor system comprising two electrochemical cells having separate electrolyte layers and a common counter-electrode layer located between the two active electrode layers.

FIG. 17E and FIG. 17F are top and cross-sectional schematic views, respectively, of another alternative embodiment of a surface-electrode sensor system comprising two electrochemical cells having separate electrolyte layers and separate counter-electrode layers.

FIG. 17G and FIG. 17H are top and cross-sectional schematic views, respectively, of yet another embodiment of a surface-electrode sensor system having separate electrolyte layers and a common counter-electrode layer, wherein the electrodes have an interdigitated configuration.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples should not be used to limit the scope of the present invention. Other features, aspects, and advantages of the versions disclosed herein will become apparent to those skilled in the art from the following description, which is by way of illustration, one of the best modes contemplated for carrying out the invention. As will be realized, the versions described herein are capable of other different and obvious aspects, all without departing from the invention. Accordingly, the drawings and descriptions should be regarded as illustrative in nature and not restrictive.

U.S. Patent Pub. No. 2013-0233728, published Sep. 12, 2013, incorporated by reference herein (hereinafter, “Day et al.”), describes amperometric sensors that include an electrically conductive active electrode comprising at least one molybdate or tungstate compound. The sensors described in Day et al. are highly responsive to NO_{X} levels at desirable temperatures (e.g., 500-600° C.), and, in some instances, are highly responsive to both NOₓ and NH₃. The molybdate and tungstate active electrode compositions described in Day et al., when applied to an oxygen ion (O²⁻) conducting electrolyte, show enhanced catalytic activity for O₂ reduction in the presence of NO_{X} and NH₃. The sensors of Day et al. detect NO_{X} and NH₃ through a catalytic effect in which the reduction of oxygen in a gas sample or gas stream is catalyzed by the presence of NO_{X} and NH₃ species on the surface of the active electrode. The sensors of Day et al. also are responsive to NO_{X} and NH₃ in the presence of steam, carbon dioxide and sulfur oxides (SO_{X}), which are additional constituents of diesel exhaust streams. It has now been found that, by proper selection of the molybdate and/or tungstate compound used in the active electrodes, and/or by proper selection of the current collectors for the active electrodes, a sensor is obtained which can be used to determine both NO_{X} and NH₃ concentrations in a gas sample (i.e., the amount of NO_{X} and the amount of NH₃, rather than the total amount of NO_{X} and NH₃). Similar sensors can be fabricated for separately detecting other gas species.

The amperometric electrochemical sensors, sensor systems and detection methods described herein are adapted to detect two or more target gas species in a gaseous analyte sample or stream. The sensors include at least two electrochemical cells, one which exhibits an additive response to the gas species of interest and one which exhibits a selective response to at least one of the gas species. In some embodiments, the two electrochemical cells of the sensor are completely separate structures, while in other embodiments the two electrochemical cells share one or more common structures (e.g., a common electrolyte layer and/or a common counter electrode layer. In general, each electrochemical cell includes an electrically conductive active electrode, an electrically conductive counter electrode and an electrolyte layer, The active and counter electrodes are separated from one another, either on opposite sides of the electrolyte layer such that oxygen ions are conducted through the electrolyte layer or on the same side of the electrolyte layer such that oxygen ions are conducted across the surface of the electrolyte layer. A current collector layer in electrical communication with the active electrode (e.g., in contact therewith) is also generally included for each electrochemical cell.

By way of example, these amperometric sensors, systems and methods may be used to detect target gas species such as NO_{X} and/or NH₃ in the oxygen-containing environment of a combusted hydrocarbon fuel exhaust, using, at least in part, an electrocatalytic effect. By way of a more specific example, the amperometric sensors, sensor systems and detection methods can operate in combustion exhaust streams (e.g., from a diesel engine of a vehicle) with significantly enhanced sensitivity to both NO_{X} and NH₃ and can be configured in such a way to enable differentiation and quantification of NO_{X} and NH₃ concentrations.

The electrochemical sensors, sensor systems and methods described herein are configured as amperometric devices/methods which respond in a predictable manner when an adsorbed gas species (e.g., NO_{X}) changes the rate of oxygen reduction at the active electrode of the device, rather than relying on the decomposition of that gas species (e.g., the catalytic decomposition of NO_{X}) in order to sense target gas (e.g., NO_{X}) concentration. A change in oxygen reduction current, caused by the presence of adsorbed NO_{X}, is used to detect the presence and/or concentration of NO_{X} in oxygen-containing gas streams. This mechanism is extremely fast and produces a current greater than what is possible from the reduction of NO_{X} alone. Further, this catalytic approach has been demonstrated to extend to NH₃.

In some embodiments, each electrochemical cell of the amperometric ceramic electrochemical sensor comprises: an electrolyte layer comprising a continuous network of a material which is ionically conducting at an operating temperature of about 400 to 700° C.; a counter electrode layer which is electrically conductive at an operating temperature of about 400 to 700° C.; and an active electrode layer which is electrically conductive at an operating temperature of about 400 to 700° C., wherein the active electrode layer is operable to exhibit a change in charge transfer in the presence of one or more target gas species and comprises a molybdate or tungstate compound. The electrolyte layer prevents physical contact between the counter electrode layer and the active electrode layer, and the electrochemical cells are operable to exhibit conductivity to oxygen ions at an operating temperature of about 400 to 700° C. Each electrochemical cell is operable to generate an electrical signal as a function of target gas concentration in an oxygen-containing gas stream, in the absence of oxygen pumping currents.

In some embodiments, one or both of the electrochemical cells further includes a counter electrode layer which is electrically conductive at an operating temperature of about 400 to 700° C., wherein the counter electrode layer is in electrical communication with (e.g., located on the surface of) the active electrode layer. The current collector layer that is more electrically conductive than the active electrode layer, particularly at an operating temperature of about 400 to 700° C., wherein the purpose of the current collector layer is to augment the electrical conductivity of the active electrode. In certain embodiments, the current collector layer also manipulates the catalytic and electrochemical reactions occurring such that reduced or enhanced sensitivity to one or more gas species of interest (e.g., NO, NO₂ or NH₃) is achieved.

The sensors described herein can be fabricated to have the ability to detect NO, NO₂ and NH₃ at levels as low as 3 ppm and/or to exhibit response times as fast as 50 ms, allowing for better system controls or even engine feedback control. The sensors, sensor systems and detection methods described further herein can be configured to operate in a temperature range of 400 to 700° C. In this temperature range the NO_{X} and NH₃ responses are significantly greater than the sensitivity to variable background exhaust gases.

While the sensors, sensor systems and detection methods described herein have applicability to the detection of NO_{X} in diesel exhaust systems, including exhaust systems found in heavy duty trucks and stationary generators, the same are also useful in a wide range of other applications in which rapid response to low levels of NO_{X} and/or NH₃ is desired. Examples include diesel generator sets, large-scale stationary power generators, turbine engines, natural gas fired boilers and even certain appliances (e.g., natural gas powered furnaces, water heaters, stoves, ovens, etc.). The sensors, sensor systems and detection methods are particularly useful in sensing low levels of NO_{X} in the presence of fixed or variable concentrations of other gases, such as O₂, CO₂, SO_{X} (SO and/or SO₂), H₂O, and NH₃.The various electrochemical sensors, sensor systems and detection methods will be described herein by reference to specific electrolyte and electrode compositions However, the electrochemical sensors, sensor systems and detection methods described herein will yield beneficial results with a wide range of such materials, as further described herein. It will be understood that the thicknesses depicted in the drawings are greatly exaggerated and are not intended to be to scale. Unless the context indicates otherwise, the terms “detect”, “detection”, and “detecting” are intended to encompass not only the detection of the presence of a target species but also sensing or measuring the amount or concentration of the target species. In the sensors, sensor systems and detection methods further described herein, the active electrode and/or current collector layer of a first electrochemical cell is exposed to two or more target gas species (e.g., NO_{X} and NH₃) such that they change the amount of oxygen reduced within the first electrochemical cell. As a result, the total concentration of the target gas species in a gas sample or stream can be correlated with the oxygen ion current through the first electrochemical cell at any given applied voltage bias and sensor temperature. The response of the first electrochemical cell of the sensor is “additive” in that the measured current at a given voltage bias and temperature can be correlated with the combined total concentration of the target gas species (e.g., NO_{X} and NH₃). At the second electrochemical cell, the active electrode and/or current collector layer of the second electrochemical cell also is exposed to the two or more target species However, the second electrochemical cell is configured and/or operated such that a first one of the target gas species (e.g., NO_{X}) measurably changes the amount of oxygen reduced within the second cell, while a second one of the target gas species (e.g., NH₃) has a significantly smaller effect on the amount of oxygen reduced within the second cell. Thus, the second electrochemical cell is “selective” with respect to a first one of the target gas species in that the measured current through the second electrochemical cell can be correlated with the concentration of the first target gas species (e.g., NO_{X}) while changes in the concentration of the second target gas species do not appreciably affect the measured current through the second electrochemical cell.

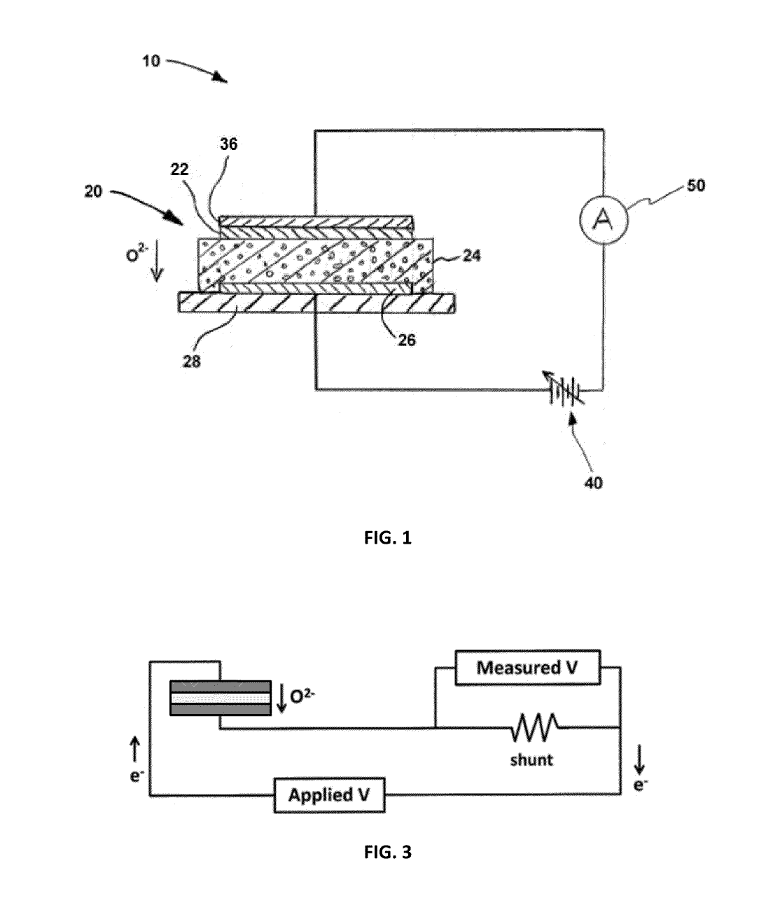

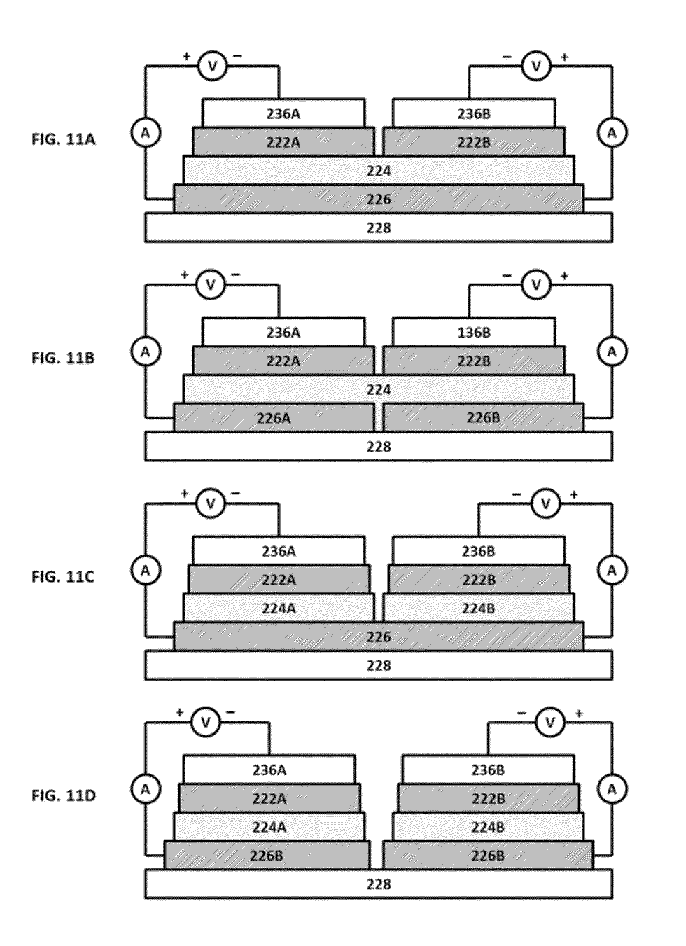

FIG. 1 illustrates an exemplary amperometric sensor system (10) comprising one electrochemical cell (20) as well as circuitry comprising a biasing source (40) and a current measuring device (50). It will be understood that embodiments of sensor systems described herein generally comprise at least two electrochemical cells, and therefore the sensor system of FIG. 1 only depicts half of such a sensor system. FIG. 11D depicts a sensor system generally comprising two electrochemical cells similar to the individual cell (20) shown in FIG. 1, with the cells deposited onto a common substrate (228).

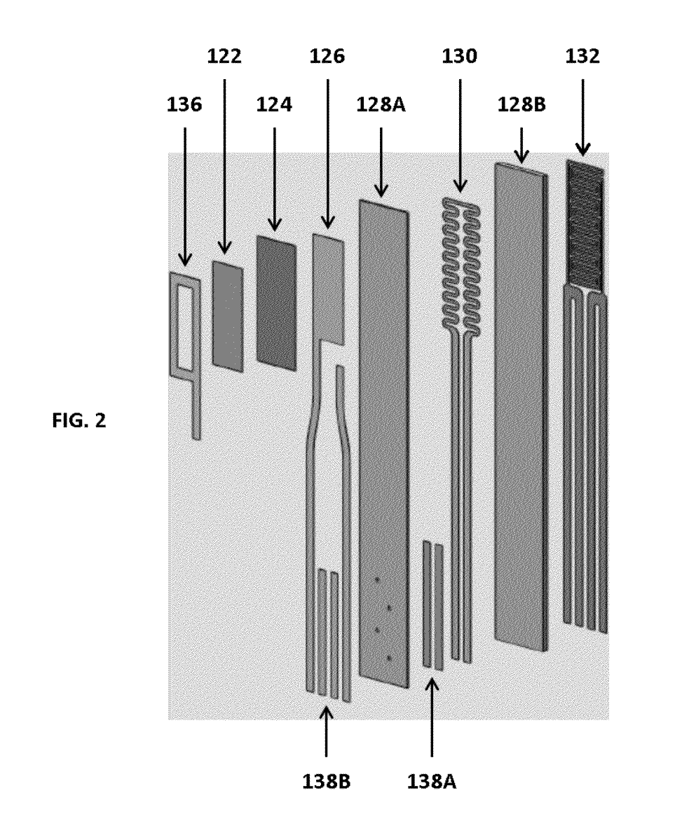

The current measuring device (50) in FIG. 1 can comprise a variety of structures and devices known to those skilled in the art, such as an ammeter. As is well known to those skilled in the art, an ammeter can be provided by the combination of a shunt resistor and a voltmeter (as shown in the embodiment of FIG. 3). Electrochemical cell (20) includes an active electrode (22), a counter electrode (26) and an oxygen-ion conducting electrolyte membrane (24) located between the electrodes (22, 26). The electrically conductive active electrode (22) comprises at least one molybdate or tungstate compound. A substrate (28) supports the counter electrode (26), as shown. Biasing source (40) is configured to apply a bias voltage between the two electrodes (22, 26), and current measuring device (50) is configured to measure the resulting current through sensor (20). Biasing source (40) can comprise any of a variety of power supplies or other devices suitable for applying a bias between the active electrode (22) and the counter electrode (26).

Embodiments of the sensors described herein include a substrate, in combination with the described electrochemical cells, to provide mechanical support. The substrate may comprise any suitable insulating material, for example, an insulating ceramic material (e.g., aluminum oxide) or a metal or cermet material coated with an insulating material. In one embodiment, a sensor includes a zirconia substrate, or more specifically, an yttrium-stabilized zirconia (YSZ) substrate.

When active electrode (22) is exposed to an oxygen-containing gas and a voltage bias is applied between electrodes (22, 26), with electrochemical cell (20) heated to an operating temperature, oxygen molecules are reduced at the active electrode (22). The resulting oxygen ions are conducted through electrolyte membrane (24) to counter electrode (26), whereat the oxygen ions are oxidized to reform O₂ and generate a measurable current. In the embodiment shown in FIG. 1, electrolyte membrane (24) is sufficiently porous such that the O₂ molecules generated at counter electrode (26) will escape from cell (20) through porous electrolyte membrane (24). In the embodiment shown, electrolyte membrane (24) extends over the sides of counter electrode (26) such that counter electrode (26) is fully encapsulated between electrolyte membrane (24) and substrate (28). Since the substrate (28) is typically dense (no through porosity which would allow the venting of oxygen gas), oxygen from the counter electrode will be vented through the porous electrolyte.

In alternative embodiments further described herein, the active and counter electrodes of each electrochemical cell are in spaced apart relationship on the same surface of the electrolyte membrane (also referred to as a surface electrode sensor).

Any of a variety of molybdate and/or tungstate compounds are suitable for use in the active electrode such as compounds of the formula A_{X}(Mo_{(1-Z)}W_{Z})_{Y}O_{(X+3Y)}, wherein X and Y are each independently selected integers from 1 to 5, 0≦Z≦1, and A is one or more ions that form binary compounds with Mo and/or W. By way of more specific example, A is one or more of Mg, Zn, Ni, Co, Fe, Mn, Cu, Ca, Sr, Ba, and Pb. In some embodiments, X and Y are both 1, and Z is 0. Particular examples of such molybdate compounds include: MgMoO₄, ZnMoO₄, NiMoO₄, CoMoO₄, FeMoO₄, MnMoO₄, CuMoO₄, CaMoO₄, SrMoO₄, BaMoO₄, and PbMoO₄. In other embodiments, X and Y are both 1, and Z is 1. Particular examples of such tungstate compounds include: MgWO₄, ZnWO₄, NiWO₄, CoWO₄, FeWO₄, MnWO₄, CuWO₄, CaWO₄, SrWO₄, BaWO₄, and PbWO₄.

The active electrode comprising at least one molybdate or tungstate compound may have a variety of specific compositions, including, for example:
(a) a molybdate compound (A_{X}Mo_{Y}O_{(X+3Y)}) or a tungstate compound (A_{X}W_{Y}O_{(X+3Y)}), including, for example, an active electrode comprising more than 30%, more than 50%, more than 80% or even more than 90% (by volume) of the molybdate or tungstate compound;
(b) one or more compounds having the formula A_{X}(Mo_{(1-Z)}W_{Z}) _{Y}O_{(X+3Y)}, wherein X and Y are each independently selected integers from 1 to 5, 0<Z<1, and A is one or more of Mg, Zn, Ni, Co, Fe, Mn, Cu, Ca, Sr, Ba, and Pb;
(c) a composite mixture of two or more compounds chosen from the group consisting of molybdate and tungstate compounds, such as a composite mixture of at least one molybdate compound and at least one tungstate compound;
(d) a composite mixture of one or more ceramic electrolyte materials and one or more of (a)-(c);
(e) a composite made from a ceramic phase comprising one or more of (a)-(d), and a metallic phase (e.g., silver, gold, platinum, palladium, rhodium, ruthenium, iridium or alloys or mixtures thereof); or
(f) a mixture of two or more of (a)-(e).
   In some of the above embodiments, one or more additives or other materials may be added to the active electrode composition during fabrication, while in other embodiments no such additives are included.

The above-described molybdate and tungstate compounds, as well as the above-described solid solutions of molybdate and tungstate compounds, may be doped with one or more metals. In addition, or alternatively, one or more oxides may be added, such as manganese oxide, iron oxide, cobalt oxide, vanadium oxide, chromium oxide, tin oxide, niobium oxide, tantalum oxide, ruthenium oxide, indium oxide, titanium oxide, and zirconium oxide. When employed, these oxide additives may be present at an amount of between about 0.1 and 10% by volume in the active electrode layer, or between about 1 and 3% by volume in the active electrode layer.

As noted above, in some embodiments the sensing electrode comprises a multi-phase composite of: (a) a molybdate and/or tungstate-containing ceramic phase (e.g., a molybdate, a tungstate, a solid solution or composite mixture of a molybdate and a tungstate, or a composite mixture of one or more of the foregoing and an electrolyte); and (b) a metallic phase (Ag, Au, Pt, Pd, Rh, Ru, Ir, or alloys or mixtures thereof). It should be kept in mind that the tungstate/molybdate ceramic phase of such composites may itself comprise more than one phase, such as a composite mixture of one or more molybdate and/or tungstate compounds and an electrolyte.

For the above-described multi-phase ceramic/metal composite materials, the amount of the metallic phase can range from about 0.1% to 10% by weight or about 30 to 70% by volume. In the multi-phase ceramic/metal composites having low levels of the metallic phase (e.g., about 0.1% to 10%, or about 1% to 5% by weight), Pt, Pd, Rh, Ru, or Jr (or alloys of mixtures thereof) are particularly useful. For the higher levels of the metallic phase (e.g., about 30% to 70%, or about 40% to 60% by volume), Ag, Au, Pt, Pd, Rh, Ru, or Jr (or alloys or mixtures thereof) may be used in order to improve electrical conductivity (although some sensitivity may be sacrificed).

As noted above, in some embodiments the sensing electrode comprises a composite mixture of: (a) one or more ceramic electrolyte materials (e.g., gadolinium-doped ceria, “GDC,” or samarium-doped ceria, “SDC”); (b) one or more molybdate and/or tungstate compounds; and, optionally, (c) a metallic phase (e.g., silver, gold, platinum, palladium, rhodium, ruthenium, iridium, or alloys or mixtures thereof). In these embodiments, the ceramic electrolyte material(s) in the sensing electrode (22) may be any of the electrolytes described below for electrolyte membrane (24), or another ceramic electrolyte material which conducts electricity through the conduction of oxygen ions (i.e., ionic conductivity rather than electronic conductivity). By way of example, suitable ceramic electrolytes for use in the active electrode include:
(a) cerium oxide doped with one or more of Ca, Sr, Sc, Y, Pr, Nd, Pm, Sm, Eu, Gd, Tb, Dy, Ho, Er, Tm, Yb, or La;
(b) zirconium oxide doped with one or more of Ca, Mg, Sc, Y, or Ce; and
(c) lanthanum gallium oxide doped with one or more of Sr, Mg, Zn, Co, or Fe.
   In more specific embodiments, the ceramic electrolyte used in the sensing electrode comprises cerium oxide doped with one or more of Ca, Sr, Sc, Y, Pr, Nd, Pm, Sm, Eu, Gd, Tb, Dy, Ho, Er, Tm, Yb, or La (e.g., GDC or SDC).

The relative amounts of ceramic electrolyte and one or more molybdate/tungstate compounds in the composite mixtures described in the previous paragraph may be varied depending on, among other things, the nature of the application (e.g., the analyte gas stream/sample and surrounding environment), the configuration of the sensor and/or sensor system, the desired sensitivity, the identity of the target gas(es), etc. In some embodiments, the volumetric ratio of ceramic electrolyte(s) to molybdate/tungstate compound(s) in the active electrode is between about 1:9 and 9:1. In other embodiments, this ratio is between about 2.5:7.5 and 7.5:2.5, or even between about 4:6 and 6:4. And in still other embodiments this ratio is about 1:1. It should be pointed out that the foregoing volumetric ratios are based upon the ratio of the total volume of ceramic electrolytes to the total volume of molybdate and tungstate compounds in the sensing electrode layer in question. When the composite mixtures described in the preceding paragraph include a metallic phase, the nature and amount of the metallic phase may be any of the various metals and amounts described previously.

In some embodiments, a current collector layer is provided for the active electrode layer of the electrochemical cells. The current collector layer that is more electrically conductive than the active electrode layer, and therefore augments the electrical conductivity of the active electrode so as to increase signal strength. And in certain embodiments the current collector layer also manipulates the catalytic and electrochemical reactions occurring such that reduced or enhanced sensitivity to one or more gas species of interest (e.g., NO, NO₂ or NH₃) is achieved.

For example, electrochemical cell (20) in FIG. 1 includes a current collector layer (36). Active electrode layer (22) is adjacent electrolyte membrane (24), while current collector layer (36) is located over active electrode layer (22), and the current collector layer (36) has a higher electrical conductivity than the active electrode layer (22). In this particular embodiment, the current collector layer is configured as a full coverage current collector in that it covers at least about 90% of the top surface of the active electrode layer (22).

In alternative embodiments, particular those in which the current collector is not configured to manipulate the catalytic and electrochemical reactions in order to reduce or enhance sensitivity to target gas species, the current collector can be configured to cover about 10-25% of the surface of the active electrode. By way of example, current collector layer (36) can be configured similar to current collector (136) in FIG. 2 such that the current collector covers the perimeter of the active electrode layer (i.e., has a central opening). As yet another alternative for a non-active current collector, the current collector layer (36) can be arranged in a grid pattern or as a mesh (e.g., interconnected strands) which provide a plurality of openings such that the gas to be sampled may pass therethrough to the active electrode layer (22). In these arrangements, the material forming the current collector layer (36) may itself be dense (i.e., non-porous), since the gas to be sampled will pass through the openings in the grid or mesh to reach the active electrode layer (22). It also should be noted that when the active electrode has sufficient electrical conductivity, then a current collector layer is not necessary.

As for the composition of the current collector layer, when the current collector is used to augment the electrical conductivity of the active electrode rather than manipulate the catalytic and electrochemical reactions, the current collector layer can comprise a metallic material (e.g., platinum or gold). Alternatively, the current collector layer can comprise a cermet comprising a metal (e.g., platinum or gold) and a ceramic phase (GDC, SDC, zirconium-doped ceria (ZDC), yttrium stabilized zirconia (YSZ), scandium stabilized zirconia (ScSZ), or one of the other ceramic electrolytes mentioned as being suitable for use in the active electrode), wherein the metal content of the cermet is sufficient to make the electrical conductivity of the current collector layer higher than that of the active electrode layer (22A). As further discussed herein, such cermet current collectors can be used to manipulate the catalytic and electrochemical reactions of the electrochemical cells of the sensor (e.g., to provide reduced or enhanced sensitivity to one or more gas species of interest). In particular, cermet current collectors comprising gold and a ceramic electrolyte (e.g., GDC) provide additive behavior with respect to NO_{X} and NH₃, whereas cermet current collectors comprising platinum and a ceramic electrolyte (e.g., ScSz) provide selective behavior with respect to NO_{X} in the presence of NH₃,

The counter electrode of the electrochemical cells of the sensors described herein can comprise any of a variety of materials, depending in part on the configuration of the electrochemical cells. For example, the counter electrode can comprise any of the compositions described above with respect to the current collector, i.e., a metallic material such as platinum or gold, or a cermet comprising a metal (e.g., platinum or gold) and a ceramic phase (GDC, SDC, ZDC, YSZ or ScSZ). In the case of the electrochemical cell (20) in FIG. 1, counter electrode (26) is platinum. Other suitable materials for the counter electrodes of the sensors described herein include:
(a) a metal comprising Ag, Au, Pt, Pd, Rh, Ru, or Ir, or an alloy, mixture or cermet of any of the foregoing (e.g., a cermet comprising one or more of these metals, particularly Pt, and YSZ, ScSZ, GDC or SDC); and
(b) various other conductive materials suitable for sensor fabrication, particularly materials which catalyze the re-oxidation of oxygen ions to molecular oxygen.

In the case of cermet current collectors, particularly those used to manipulate the response of the electrochemical cells, the current collector comprises about 40 to 80 vol %, or about 50 to 70 vol % of the metal phase (e.g., Pt or Au), with the remainder being the ceramic electrolyte phase (e.g., GDC or ScSz).

As for the ionically-conducting electrolyte membrane of the electrochemical cells used in the sensors described herein, suitable materials include gadolinium-doped ceria (Ce₁₋ₓGd_{X}O_{2-X/2}, wherein X ranges from approximately 0.05 to 0.40), and samarium-doped ceria (Ce₁₋ₓSm_{X}O_{2-X/2}, where X ranges from approximately 0.05 to 0.40). Further ceramic electrolyte materials for use as the electrolyte membrane (e.g., 24 in FIG. 1) include yttrium-doped ceria (YDC), cerium oxide doped with other lanthanide elements, and cerium oxide doped with two or more lanthanide or rare earth elements. Still other suitable electrolyte materials include: fully or partially doped zirconium oxide, including but not limited to yttrium stabilized zirconia (YSZ) and scandium doped zirconia (ScSZ); other ceramic materials that conduct electricity predominantly via transport of oxygen ions; mixed conducting ceramic electrolyte materials; and mixtures of two or more of the foregoing. In addition, an interfacial layer of GDC, SDC or another suitable electrolyte material may be provided between the electrolyte membrane and one or both of the active and counter electrodes.

As mentioned previously, the sensor and sensor system embodiments described herein generally comprise at least two electrochemical cells, wherein the first cell is configured (or operated) so as to provide an additive response with respect to two or more target gas species of interest (e.g., NO_{X} and NH₃) and the second cell is configured (or operated) so as to provide a selective response with respect to a first one of the target gas species but not a second one of the target gas species. For NO_{X} and NH₃ sensing, for example, using the above-described active electrode materials, a sensor can be constructed with two electrochemical cells having different active electrodes: one that is sensitive to both NO_{X} and NH₃ and one that is sensitive only to NO_{X} (with little or no sensitivity to NH₃). Total NO_{X} plus NH₃ concentration can be quantified by measuring current when applying a bias to the first electrochemical cell, the NO_{X} concentration can be quantified by measuring current when applying a bias to the second electrochemical cell, and the NH₃ concentration can be calculated by subtraction (total NO_{X} plus NH₃ concentration minus NO_{X} concentration). Thus, both NO_{X} and NH₃ can be measured in a single sensor. The two electrochemical cells can be physically combined into one structure, or two physically separate electrochemical cells may be employed.

Alternatively, a sensor can be constructed with two electrochemical cells having different current collector materials and the same or different active electrode materials, such that one cell is sensitive to both NO_{X} and NH₃, and the other cell is sensitive only to NO_{X}. Total NO_{X} plus NH₃ concentration can be quantified by measuring current when applying a bias to the first electrochemical cell, the NO_{X} concentration can be quantified by measuring current when applying a bias to the second electrochemical cell, and the NH₃ concentration can be calculated by subtraction. Thus, both NO_{X} and NH₃ can be measured in a single sensor. As before, the two electrochemical cells can be physically combined into one structure, or two physically separate electrochemical cells may be employed.
as yet another alternative, a sensor can be constructed with two electrochemical cells having active electrodes of the same or similar composition, with or without associated current collectors of the same or similar composition, and the sensor can be operated with forward bias (i.e., from active electrode to counter-electrode) applied to one electrochemical cell to detect and quantify total NO_{X} plus NH₃, and with reverse bias (i.e., from counter electrode to active electrode) applied to the second electrochemical cell to detect and quantify either NO_{X} or NH₃ (with the other concentration calculated by subtraction). Thus, both NO_{X} and NH₃ can be measured in a single sensor. As before, the two electrochemical cells can be physically combined into one structure, or two physically separate electrochemical cells may be employed.

In another alternative embodiment, a sensor can be constructed with two electrochemical cells, both having an active electrode of the same or different composition, with or without associated current collectors of the same or similar composition, and the sensor can be operated such that one cell is operated with forward bias (i.e., from active electrode to counter-electrode) to detect and quantify total NO_{X}, and the second cell operated with negative bias (i.e., from counter electrode to active electrode) to detect and quantify NH₃. In this instance, one cell is selective to NO_{X} and the other cell is selective to NH₃. Thus, both NO_{X} and NH₃ can be measured in a single sensor. As before, the two electrochemical cells can be physically combined into one structure, or two physically separate electrochemical cells may be employed.

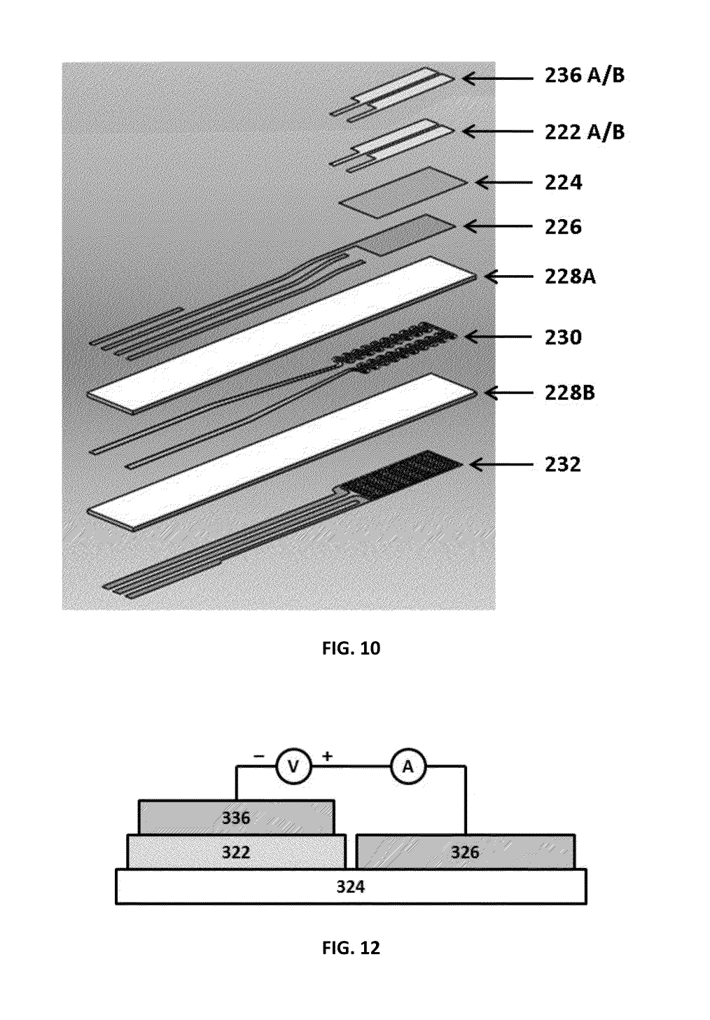

In any of the above-described embodiments of a sensor comprising two (or more) electrochemical cells, the two cells can be configured so as to share a common substrate and, in some instances, a common electrolyte layer and/or a common counter electrode layer. FIGS. 10 and 11A-11D depict such sensor arrangements wherein the counter electrode (226) is buried (located on the opposite side of the electrolyte layer from the active electrode layer). As used herein, a “buried” counter electrode does not necessarily mean that the entire counter electrode is covered by the electrolyte and substrate (as shown in FIG. 1). Rather, this term simply means that the counter electrode is on the opposite side of the electrolyte from the active electrode, rather than being located on the same surface of the electrolyte. In the example structures of FIGS. 10 and 11A-11D, the current collector (236A, 236B) can be omitted entirely, can be configured similar to that shown in FIG. 2 (or as a grid, mesh or other open structure), or can be configured as a full coverage current collector (as shown in FIG. 10).

In the example depicted in FIGS. 10 and 11A, a sensor comprising two electrochemical cells is fabricated by sequentially depositing the necessary layers onto an appropriate insulating substrate (228): a single, common counter electrode (226); a single, common electrolyte layer (224) that is deposited on the counter electrode; a first active electrode layer (222A) that is deposited on a portion of the electrolyte layer surface (to define a first electrochemical cell); a second active electrode layer (222B) that is deposited on a different portion of the electrolyte layer surface (to define a second electrochemical cell); and (optionally) a first current collector layer (226A) that is deposited on the first active electrode layer; and (optionally) a second current collector layer (226B) that is deposited on the second active electrode layer. In the embodiment shown in FIG. 10, the substrate comprises first and second substrate layers (228A, 228B). A platinum resistive heater (230) is embedded between the substrate layers, and a platinum RTD (232) is laminated to the bottom surface of the second substrate layer (228B). Leads for the electrodes, current collectors and other sensor components are also depicted.

In the example depicted in FIG. 11B, a sensor comprising two electrochemical cells is fabricated by sequentially depositing the necessary layers onto an appropriate insulating substrate (228): a first counter electrode layer (226A) that is deposited on a portion of the substrate (228); a second counter electrode layer (226B) that is deposited on a different portion of the substrate (228); a single, common electrolyte layer (224) that is deposited on the first and second counter electrodes; a first active electrode layer (222A) that is deposited on a portion of the electrolyte layer surface (to define a first electrochemical cell); a second active electrode layer (222B) that is deposited on a different portion of the electrolyte layer surface (to define a second electrochemical cell); and (optionally) a first current collector layer (226A) that is deposited on the first active electrode layer; and (optionally) a second current collector layer (226B) that is deposited on the second active electrode layer.

As yet another specific example, as depicted in FIG. 11C two electrochemical cells are fabricated by sequentially depositing the necessary layers onto an appropriate insulating substrate (228): a single, common counter electrode (226); a first electrolyte layer (224A) that is deposited on one area of the counter electrode; a second electrolyte layer (224B) that is deposited on a second area of the counter electrode; a first active electrode layer (222A) that is deposited on the first electrolyte layer (to define a first electrochemical cell); a second active electrode layer (222B) that is deposited on the second electrolyte layer (to define a second electrochemical cell); and (optionally) a first current collector layer (236A) that is deposited on the first active electrode layer; and (optionally) a second current collector layer (236B) that is deposited on the second active electrode layer.

As still another specific example, as depicted in FIG. 11D two electrochemical cells are fabricated by sequentially depositing the necessary layers onto an appropriate insulating substrate (228): a first counter electrode layer (226A) that is deposited on a portion of the substrate (228); a second counter electrode layer (226B) that is deposited on a different portion of the substrate (228); a first electrolyte layer (224A) that is deposited on the first counter electrode layer; a second electrolyte layer (224B) that is deposited on the second counter electrode layer; a first active electrode layer (222A) that is deposited on the first electrolyte layer (to define a first electrochemical cell); a second active electrode layer (222B) that is deposited on the second electrolyte layer (to define a second electrochemical cell); and (optionally) a first current collector layer (236A) that is deposited on the first active electrode layer; and (optionally) a second current collector layer (236B) that is deposited on the second active electrode layer.

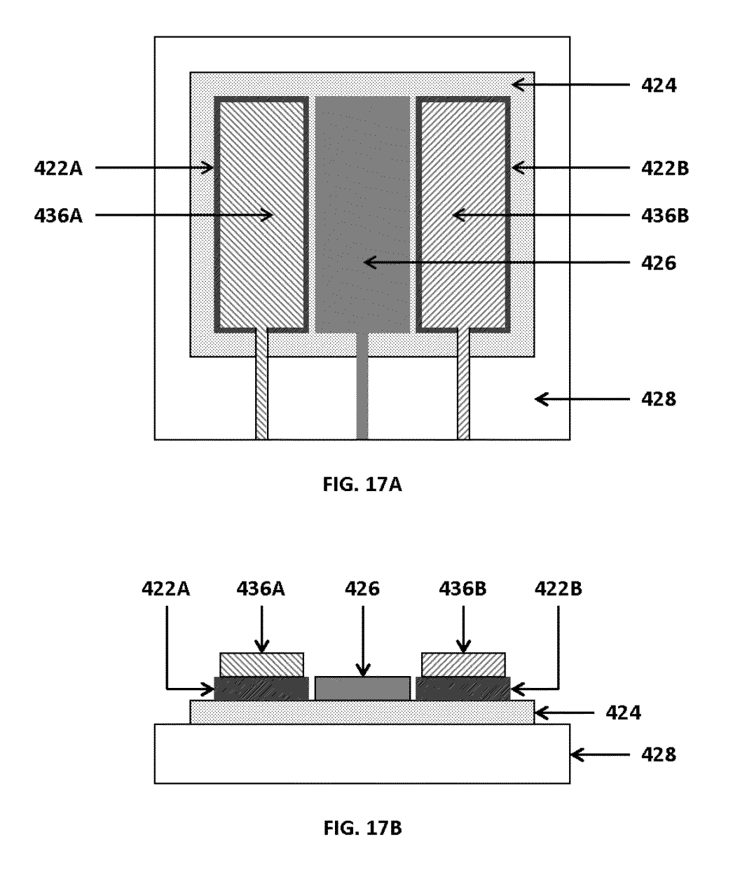

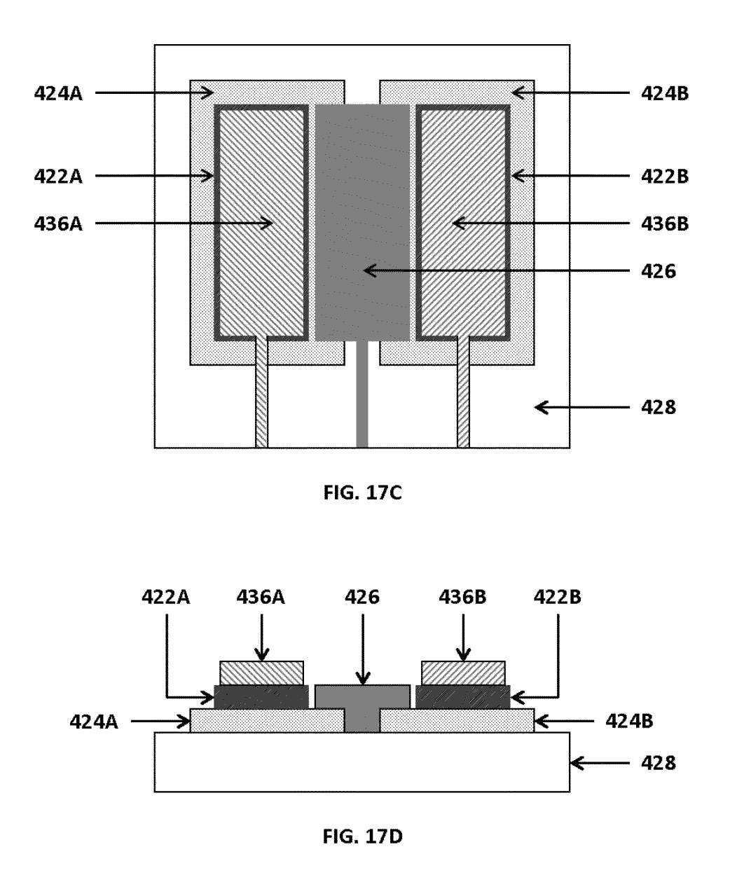

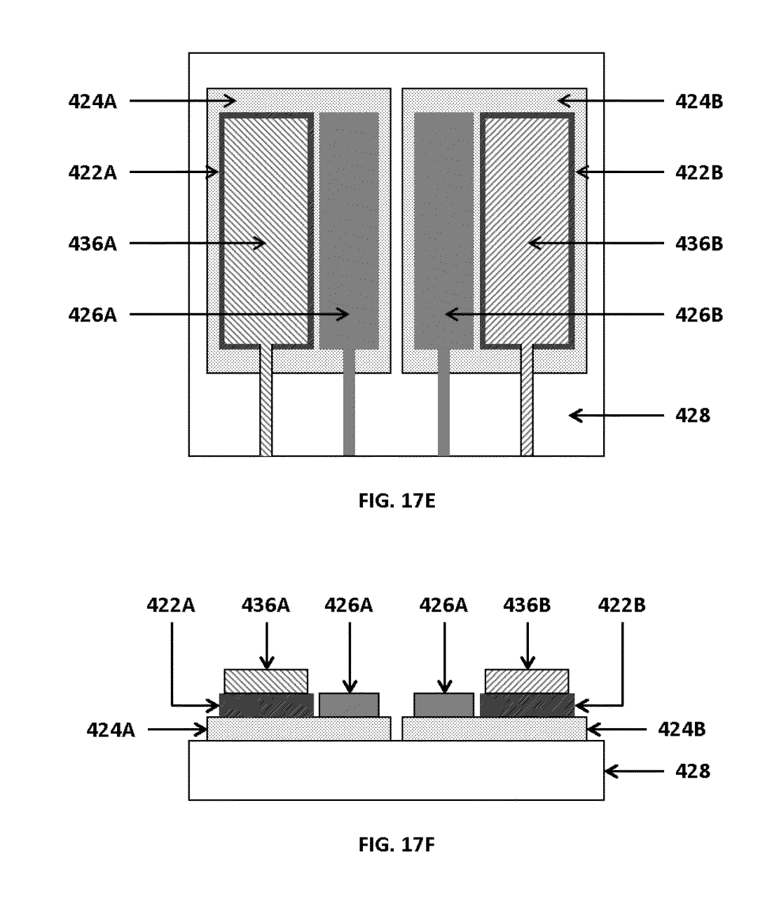

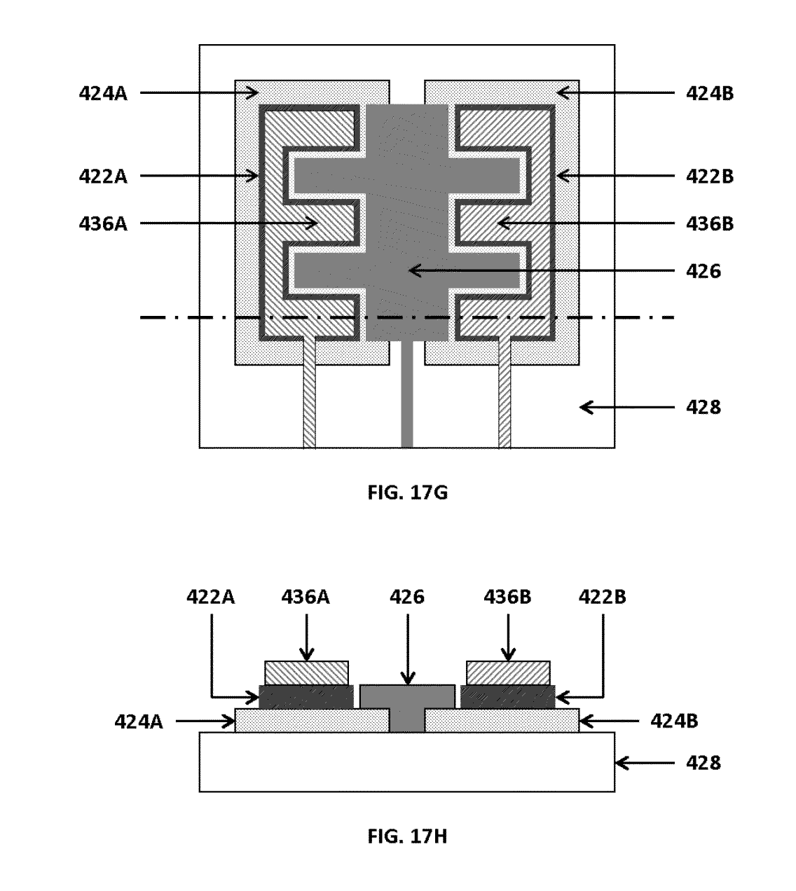

Alternatively, in embodiments wherein the current collector layers are adapted to manipulate the catalytic and electrochemical reactions occurring such that reduced or enhanced sensitivity to one or more gas species of interest (e.g., NO, NO₂ or NH₃) is achieved in the electrochemical cells, a surface electrode arrangement is employed for each electrochemical cell wherein the active electrode and counter electrode are in spaced apart relationship on the same surface of the electrolyte with a full coverage current collector over the active electrode layer. Nevertheless, in these embodiments the two cells can be configured so as to share a common substrate and, in some instances, a common electrolyte layer and/or a common counter electrode layer. FIGS. 17A-H depict such sensor arrangements. It should be understood, however, that the arrangements shown in FIGS. 17A-H can also be used for embodiments wherein the material of the active electrode controls the electrochemical cell behavior, and in these instances the current collector layers can be omitted (if the active electrode layer is sufficiently conductive) or the current collector layers can be configured as a non-full coverage current collector (e.g., similar to that shown in FIG. 2 or as a grid or mesh).

In the example depicted in FIGS. 17A and 17B, a sensor comprising two electrochemical cells is fabricated by sequentially depositing the necessary layers onto an appropriate insulating substrate (428):: a single, common electrolyte layer (424); a first active electrode layer (422A) that is deposited on a portion of the electrolyte layer surface; a second active electrode layer (422B) that is deposited on a different portion of the electrolyte layer surface; a single, common counter-electrode layer (426) that is deposited on a different portion of the electrolyte layer in close proximity to the first and second electrode layers (e.g., between the first and second active electrode layers) thus defining two electrochemical cells, a first current collector layer (436A) that is deposited on the first active electrode layer; and a second current collector layer (436B) that is deposited on the second active electrode layer.

In the example depicted in FIGS. 17E and 17F, a sensor comprising two electrochemical cells is fabricated by sequentially depositing the necessary layers onto an appropriate insulating substrate (428): a first electrolyte layer (424A) that is deposited on one area of the insulating substrate; a second electrolyte layer (424B) that is deposited on a second area of the insulating substrate; a first active electrode layer (422A) that is deposited on a portion of the first electrolyte layer; a second active electrode layer (422B) that is deposited on a portion of the second electrolyte layer; a first counter-electrode layer (426A) that is deposited on the first electrolyte layer in close proximity to the first electrode layer (thus defining a first electrochemical cell); a second counter-electrode layer (426B) that is deposited on the second electrolyte layer in close proximity to the second electrode layer (thus defining a second electrochemical cell); a first current collector layer (426A) that is deposited on the first active electrode layer; and a second current collector layer (436B) that is deposited on the second active electrode layer.

In the example depicted in FIGS. 17C and 17D, a sensor comprising two electrochemical cells is fabricated by sequentially depositing the necessary layers onto an appropriate insulating substrate (428): a first electrolyte layer (424A) that is deposited on one area of the insulating substrate; a second electrolyte layer (424B) that is deposited on a second area of the insulating substrate; a first active electrode layer (422A) that is deposited on a portion of the first electrolyte layer; a second active electrode layer (422B) that is deposited on a portion of the second electrolyte layer; a single, common counter-electrode layer (426) that is deposited on both the first and second electrolyte layers (and an area of the insulating substrate between the first and second electrolyte layers) in close proximity to and between the first and second electrode layers (thus defining two electrochemical cells); a first current collector layer (436A) that is deposited on the first active electrode layer; and a second current collector layer (436B) that is deposited on the second active electrode layer.

The example depicted in FIGS. 17G and 17H is similar to that of FIGS. 17C and 17D. In the embodiment of FIGS. 17G and 17H, however, the active and counter electrodes are interdigitated while maintaining a minimal electrode path length therebetween.

The sensors and sensor systems herein may be configured to be compatible with various application environments, and may include substrates with modifications to provide structural robustness, the addition of one or more heaters to control sensor temperature, and/or the addition of a resistance temperature detector (“RTD”), a thermistor, a thermocouple or other device to measure temperature and provide feedback to the electronic controller for temperature control. An alternative temperature measurement approach, based on the use of impedance of the electrolyte layer at a specific frequency, also can be used; this may require the addition of specific features to the sensor device architecture. Modifications may also be made to the overall sensor size and shape, external packaging and shielding to house and protect the sensor, and appropriate leads and wiring to communicate the sensor signal to an external device or application.

As mentioned previously, in sensors wherein the counter electrode is buried, the electrolyte membrane may be porous to allow oxygen gas to vent from the counter electrode back to the exhaust gas environment. For example, the electrolyte membrane may have about 10 to 70% porosity, about 20 to 60% porosity, or about 30 to 50% porosity). Use of a porous electrolyte has the added advantage of allowing an electrolyte of different thermal expansion coefficient from the substrate material to be sintered onto the substrate with good integrity. Alternatively, the electrolyte can be made dense such that oxygen gas will not be vented through the electrolyte during use. In such an embodiment, a vent path is added under the counter electrode, for example, to allow oxygen to escape from the sensor through the vent path.

Embodiments of the sensors described herein include a substrate, in combination with the described electrochemical cells, to provide mechanical support. The substrate may comprise any suitable insulating material, for example, an insulating ceramic material (e.g., aluminum oxide). The sensor may optionally include a heater which is electrically isolated from the electrolyte and electrodes. In some embodiments, the heater comprises a resistive heater formed, for example, from a conductive metal such as, but not limited to, platinum, palladium, silver, or the like. The heater may, for example, be applied to or embedded in the substrate, or applied to the cell through another insulating layer such as aluminum oxide. In still other embodiments, a temperature measurement mechanism is applied to the sensor to measure temperature and feed that back to the electronic controller to enable closed-loop temperature control. The temperature measurement mechanism, for example, is a resistance temperature device made from a conductive metal or metal/ceramic composite with a high temperature coefficient of resistance (e.g., platinum or a platinum based cermet).

In a specific embodiment such as that shown in FIG. 2, the electrochemical sensor is made using tape casting and screen printing techniques commonly used during the manufacture of multilayer ceramic capacitors and multilayer ceramic substrates. The first part of this process involves tape casting of aluminum oxide sheets (or tape). In the green state, via holes are cut into the substrate using a laser cutter or punch, providing electrical pathway connections from an embedded heater or other structures to the contact pads on an outer surface of the ceramic element. Platinum (or platinum based material) is screen printed onto one face of a green aluminum oxide tape in patterns that, after sintering, will provide a heater. Also in the green state, in the case of a buried counter electrode design, a counter electrode (made of any of the compositions described above) is screen printed onto one face of a green aluminum oxide tape in patterns that after sintering will provide a counter electrode. Multiple layers of green aluminum oxide tape then are aligned and stacked such that the screen-printed heater layer is in the middle and the counter electrode layer is on the opposite face. The stack of green alumina tapes then is laminated by application of uniaxial pressure at slightly elevated temperature. The via holes are filled with conductive ink, such as platinum, and the stack is sintered at high temperature to consolidate the aluminum oxide substrate. A porous ceria-based electrolyte (GDC or SDC) layer (or other electrolyte material) is then applied onto the counter electrode face of the substrate by screen printing and sintering. Platinum (or platinum based material) is screen printed onto the outer face of the sintered element, in patterns that, after sintering, will provide an RTD to enable a temperature measurement. Alternatively, another suitable material for an RTD may be applied in the green state prior to sintering of the aluminum oxide substrates and co-sintered therewith. A glass layer can be applied over the RTD and cured to protect the RTD in the application. Alternatively, both the heater and RTD layers can be embedded within the substrate in the green state and connections made with platinum vias (as described above), or only the platinum RTD can be embedded within the substrate, and the heater layer can be printed on the exterior surface and protected with a glass layer. Alternatively, the RTD can be omitted, and another means used for temperature measurement and control can be used.

Manufacture of the electrochemical cell or sensor is then completed by screen printing of the active electrode layer (made of any of the compositions described above) onto the porous electrolyte layer, followed by sintering of the active electrode layer to promote adhesion. A current collector layer than can be applied (either as a porous layer or in a pattern) such that it allows exhaust gas exposure to the active electrode layer while providing an electrically conducting pathway to the sensor pads. A porous ceramic coating, such as a zeolite or gamma alumina, can additionally be applied over the active electrode to protect it in the application and calcined to improve adhesion. It should be noted that multiple electrochemical cells or sensors can be made simultaneously with the above described process by array processing.

Sensor systems are formed, for example, by coupling one or more of the sensors described herein with one or more electronic controllers configured to controllably apply the bias voltage, control temperature (e.g., through pulse width modulation of the input voltage to the heater based on the sensor temperature measurement supplied to the controller). In some embodiments, the controller is configured to provide a conditioned sensor output, such as calibrated or linearized output.

Methods of detecting, sensing and/or monitoring the concentration of one or more target gas species such as NO_{X} and/or NH₃ are also provided, employing any of the various sensors and sensor systems described herein. In these methods, a bias voltage is applied to the electrochemical cells of the sensor and the resulting current is measured. The measured current is correlated with the target gas species at a sensor temperature, based on previously compiled sensor data. In general, the measured current changes as the concentration of target gas species in the gas sample or stream increases. By using predetermined sensor response data, at any given sensor operating temperature and applied bias voltage, target gas species may be determined on the basis of the generated current through the sensor cell.

Various additional features and advantages of the amperometric sensors, sensor systems and methods will become evident from the devices and results obtained as described under the Examples that are described later.

### Buried Counter-Electrode Sensors for Dual NO_{X}/NH₃ Detection

As noted previously, sensors can be constructed with two active electrodes, effectively providing two different electrochemical cells, in order to provide for measurement of both NO_{X} concentration and NH₃ concentrations. For the purposes of testing, exemplary sensors were fabricated as a single electrochemical cell and tested under conditions that would enable the design of dual NO_{X}/NH₃ sensors having multiple electrochemical cells. Through this testing, applicants have discovered multiple approaches for fabricating sensors for measuring both NO_{X} and NH₃ concentrations. These approaches generally involve building and operating one electrochemical cell such that the cell exhibits an additive response with respect to NO_{X} and NH₃ (i.e., the identical response to all three species), and building and operating a second electrochemical cell such that the cell exhibits a selective response with respect to NO_{X} in the presence of NH₃ (i.e., identical response to NO and NO₂ and a diminished or no response to NH₃).

An additive response means that the magnitude of the signal provided by the electrochemical cell is proportional to the total combined concentration of the analytes (e.g., NO, NO₂ and NH₃) in the gas sample or gas stream being analyzed. Thus, in the amperometric sensors described herein, a an individual electrochemical cell of a sensor which exhibits an additive response to NO, NO₂ and NH₃ will provide a signal which is proportional to the total, combined concentration of NO, NO₂ and NH₃. In other words, the electrochemical cell of the sensor exhibits approximately equal responses to NO, NO₂ and NH₃ such that approximately the same current is generated when that electrochemical cell is exposed to a given concentration of NO, NO₂ and NH₃ (e.g., approximately the same current is generated when the electrochemical cell is exposed to 20 ppm NO, 20 ppm NO₂ or 20 ppm NH₃). In particular, an individual electrochemical cell of a sensor is considered to be additive with respect to two or more analyte species when the sensitivity to each of those species is within a range of ±20% for a given concentration within the range of 10-200 ppm of the gas analyte species. As used herein, the sensitivity is the percent change in the current signal compared to the current signal in the absence of the analyte species. In some embodiments, the sensitivity to two or more analyte species of an additive electrochemical cell is within a range of ±10%, or even ±5%.

While one electrochemical cell of the sensor exhibits an additive response to two or more target gas species (e.g., NO_{X} and NH₃), the other electrochemical cell of the sensor is minimally responsive or non-responsive to one of the target gas species (e.g., either NO_{X} or NH₃)—i.e., a selective response. Selectivity is provided by either the configuration of the second electrochemical cell (e.g., the selection of the active electrode material and/or the current collector) and/or the mode of operation of the second electrochemical cell (e.g., direction of biasing). An electrochemical cell of a sensor is minimally responsive (i.e., selective) with respect to a particular analyte when the sensitivity for that analyte is less than 20% of the sensitivity to the other analyte(s) of interest at a given concentration within the range of 10-200 ppm. In some embodiments, the sensitivity to one analyte is less than 10% of the sensitivity to the other analyte(s), or even less than 5%. In one particular embodiment, when a first electrochemical cell of a sensor is additive with respect to NO_{X} and NH₃, and the second electrochemical cell of the sensor is responsive to NO_{X} but only minimally responsive or non-responsive to NH₃, it is preferred that the second electrochemical cell exhibits additive properties with respect to NO and NO₂.

As demonstrated by the testing reported further herein, Applicants have discovered that MgMoO₄ or MgWO₄, when used in the active electrode of an electrochemical cell of the amperometric sensors described in the present application, are additive with respect to NO, NO₂ and NH₃ in a gas stream (e.g., combustion engine exhaust). Nearly equal responses (±20% sensitivity) to NO, NO₂ and NH₃ are provided, such that the signal from an electrochemical cell having an active electrode comprising MgMoO₄ and/or MgWO₄ is proportional to the combined concentration of NO, NO₂ and NH₃ in a gas stream. Applicants have also discovered that CoMoO₄ or CoWO₄, when used in the active electrode of an electrochemical cell of the amperometric sensors described in the present application, are additive with respect to NO and NO₂ but minimally responsive to NH₃ in a gas stream (i.e., less than 20% of the sensitivity to NO_{X}). In other words, CoMoO₄ and CoWO₄ are selective to NO_{X} in a gas stream that includes both NO_{X} and NH₃.

This discovery allows for the fabrication of amperometric sensors having a first electrochemical cell having active electrode comprising MgMoO₄ or MgWO₄ and a second electrochemical cell having an active electrode comprising CoMoO₄ or CoWO₄. The signal from the first electrochemical cell is correlated with the total concentration of NO, NO₂ and NH₃, based on previously compiled sensor data. The signal from the second electrochemical cell is correlated with the total concentration of NO and NO₂ (i.e., NO_{X}), based on previously compiled sensor data. Then, by subtracting the NO_{X} concentration obtained using the signal from the second sensing electrode from the total concentration of NO, NO₂ and NH₃ obtained using the signal from the first sensing electrode, the concentration of NH₃ is determined.

A multilayer ceramic sensor similar to that depicted in FIG. 2 was used for the testing of various active electrode formulations and operating conditions in Examples 1-8. The sensor of FIG. 2 includes an active electrode (122), a current collector layer (136), an electrolyte membrane (124), a counter electrode (126), and first and second substrate layer (128A, 128B). An embedded platinum resistive heater (130) and a platinum RTD (132) also are included. Aluminum oxide substrate material was made using a tape casting process to yield thin (50 microns) sheets of pliable green “tape”, and multiple tape layers were laminated under pressure and heat to form green planar substrates (128A, 128B) of targeted thicknesses (500 and 800 microns, respectively). The platinum features, including the counter electrode (126), heater (130), RTD (132), and heater contact pads (138A and 138B) were screen printed onto their respective substrate layers. Multiple prints of the heater contact pads (138A and 138B) were made so that via holes in the first substrate layer (128A) were filled with platinum ink. A second lamination step consolidated the layers into one monolithic element. The elements were then cut to size, using a laser cutting process and subsequently sintered at 1550° C. to complete fabrication of the substrate. The nominal dimensions of the substrates were 8 mm wide by 50 mm long.

Next, a GDC electrolyte layer (124) was screen printed onto the counter electrode (126) at the appropriate end and face of the aluminum oxide substrate (128) and the electrolyte layer was sintered at 1400° C. to form a porous GDC electrolyte layer (124). To increase the thickness of the porous GDC electrolyte layer (124), two additional GDC layers were then screen printed onto the first GDC layer and sintered at 1400° C. each. The thickness of the porous GDC electrolyte membrane layer was approximately 45 microns. The active electrode layer (122) then was screen printed onto the GDC electrolyte layer (124), followed by annealing. Sensor fabrication was completed by screen printing the current collector layer (136), followed by annealing. As shown, the geometry of the current collector (136) was such that it only contacted the active electrode (122) along the periphery of the active electrode (122), so that most of the active electrode layer (122) was uncovered. As shown, both the active electrode (122) and current collector (136) have long tail portions which extend away from the active area of the sensor as shown (to enable electrical connections to be made).

For testing, the sensors were placed within a tubular reactor (2.5 cm diameter) and a baseline test gas simulating that of a fuel-lean diesel exhaust composition was flowed into the reactor at a rate of 0.2 slpm. The test gas was heated to the target temperature, typically 525° C.) (although the devices were fabricated with internal heaters and RTDs, these features were not used for testing of the Example sensors). The tests were performed with a constant bias voltage in the range of approximately 0.1 to 0.3 volts is applied to the sensor. Voltage was measured across a shunt resistor, in series with the sensor, to determine the current passing through the sensor, with various gases (NO_{X}, NH₃, and/or SO_{X}) being introduced into the simulated diesel exhaust atmosphere. The resistance of the shunt resistor was set such that the measured voltage across the shunt resistor in NO_{X} was in the range of 0.1 to 1 mV. The sensor testing configuration is shown in FIG. 3.

A multitude of sensors were made with the element geometry and layered configuration shown in FIG. 2. In the examples reported below, the active electrode generally comprised ˜50-55/˜43-48/˜2 weight percent mixture of the specified molybdate or tungstate (ABO₄) compound, gadolinium doped ceria (Ce_{0.9}Gd_{0.1}O_{1.95}) and platinum, respectively, as indicated in Table 1. The surface area of the GDC powder was approximately 6 m²/gram, and the surface areas of the molybdate/tungstate compounds ranged from 1 to 4 m²/gram. Platinum was first added to the GDC via incipient wetness impregnation. This combination was then mixed with the molybdate/tungstate compound and formulated into a screen printing ink. The active electrode was screen printed onto the electrolyte layer and then annealed at 1000° C. A gold based current collector ink was made by first making a GDC ink (by dispersing GDC powder into a commercial screen printing ink vehicle) and then mixing the GDC ink with a commercial gold ink (supplied by Heraeus) such that the resulting Au/GDC ink had 60 volume percent gold. Current collectors were screen printed onto the active electrode layers and annealed at 950° C.

Compositions of the ABO₄ materials tested were: MgMoO₄ (Example 1), MgWO₄ (Example 2), CoMoO₄ (Example 3), CoWO₄ (Example 4), BaMoO₄ (Example 5), BaWO₄ (Example 6) and CaWO₄ (Example 7). For these tests, the operating temperature was 525° C., the bias voltage was 200 mV, and the total amounts of NO, NO₂ and NH₃ in the sampled gas stream was 40 ppm. Responses to 40 ppm of each of NO, NO₂ and NH₃ were measured, along with combined responses to NO+NO₂ (20 ppm of each) and NO+NH₃ (20 ppm each). For the data reported in Table 2 below, signal strength is the magnitude of electrical current produced with an applied bias voltage of 200 mV in the absence of NO, NO₂ and NH₃, and sensitivity is the percent change in the current when the sensing element was exposed to 40 ppm (total) of NO, NO₂ and/or NH₃. Test results are presented in Table 2, and summarized below.

TABLE 1
Sensing Electrode Compositions: Pt/ABO₄-GDC

| | | ABO₄ | | Pt | | GDC | |
|---|---|---|---|---|---|---|---|
| Example | ABO₄ | Wt. % | Vol. % | Wt. % | Vol. % | Wt. % | Vol. % |
| 1 | MgMoO₄ | 49.85% | 65.95% | 2.67% | 0.63% | 47.48% | 33.43% |
| 2 | MgWO₄ | 54.35% | 60.86% | 2.17% | 0.64% | 43.48% | 38.50% |
| 3 | CoMoO₄ | 50.00% | 64.51% | 2.38% | 0.58% | 47.62% | 34.90% |
| 4 | CoWO₄ | 50.00% | 46.75% | 2.38% | 0.87% | 47.62% | 52.37% |
| 5 | BaMoO₄ | 54.35% | 65.43% | 2.17% | 0.57% | 43.48% | 34.00% |
| 6 | BaWO₄ | 54.35% | 63.59% | 2.17% | 0.60% | 43.48% | 35.81% |
| 7 | CaWO₄ | 54.35% | 59.22% | 2.17% | 0.67% | 43.48% | 40.11% |

TABLE 2
Summary of sensor testing results.

| | | | Sensitivities (40 ppm total of | | | | |
|---|---|---|---|---|---|---|---|
| | | Signal | NO, NO₂ and/or NH₃) | | | | |
| | ABO₄ in | Strength | | | | NO + | NO + |
| Example | Pt/ABO₄-GDC | (μA) | NO | NO₂ | NH₃ | NO₂ | NH₃ |
| 1 | MgMoO₄ | 10.6 | 35.3 | 35.3 | 28.2 | 35.6 | 30.1 |
| 2 | MgWO₄ | 19.4 | 36.2 | 36.1 | 33.7 | 29.2 | 37.0 |
| 3 | CoMoO₄ | 8.5 | 32.6 | 38.0 | −2.7 | 36.0 | 15.1 |
| 4 | CoWO₄ | 15.9 | 10.0 | 11.8 | −0.9 | 11.5 | 4.5 |
| 5 | BaMoO₄ | 28.6 | 74.9 | 74.2 | 2.3 | 62.0 | 67.8 |
| 6 | BaWO₄ | 15.6 | 63.2 | 68.1 | 34.7 | 66.7 | 46.2 |
| 7 | CaWO₄ | 27.0 | 20.3 | 28.7 | 6.8 | 19.2 | 16.8 |

Conditions: Baseline (8% O₂, 8% CO₂, 5% H₂O, 1 ppm SO₂, balance N₂): T = 525° C.; bias = 200 mV

As shown by the data reported in Table 2 above, sensors made with MgMoO₄ and MgWO₄ based active electrodes (Examples 1 and 2, respectively) exhibited nearly equal responses to 40 ppm levels of NO, NO₂, NH₃, NO+NO₂ and NO+NH₃. These electrode materials are therefore considered “additive” with respect to NO, NO₂ and NH₃. Sensors made with CoMoO₄ and CoWO₄ based active electrodes (Examples 3 and 4, respectively) exhibited nearly equal responses to 40 ppm levels of NO, NO₂ and NO+NO₂, and are therefore additive with respect to NO and NO₂. However, these active electrodes were minimally responsive to NH₃ (either alone or in the presence of NO). Therefore, these electrode materials are considered to be “selective” with respect to NO_{X} in a gas stream containing NH₃. Finally, sensors made with BaMoO₄, BaWO₄, and CaWO₄ based active electrodes (Examples 5, 6 and 7, respectively) exhibited inconsistent behaviors that were, at times, intermediate to additive and selective electrodes.

There is considerable benefit to dual reporting of both NO_{X} and NH₃. In one embodiment, in order to resolve NO_{X} and NH₃ amounts within an exhaust stream, a minimum of two different active electrode materials, each with different response characteristics to NO_{X} and NH₃, are employed. One solution is to build a sensor with two electrochemical cells having different active electrodes: a first cell having an active electrode that is equally responsive to NO, NO₂ and NH₃ (i.e., additive), enabling a measurement of total NO_{X} plus NH₃ content; and a second cell having an active electrode that responds equally to NO and NO₂ but is minimally responsive to NH₃ (i.e., selective to NO_{X}), enabling a measurement of NO_{X} content. Thus, NO_{X} and NH₃ contents can be accurately calculated from the two measurements.

Another way of looking at the two types of electrode materials is from the perspective of the ammonia oxidation reaction. In general, the oxidation of ammonia can proceed through two primary routes, resulting in the formation of either NO or N₂:
NO Formation Reaction: 4 NH₃+5 O₂→4 NO+6 H₂O (ΔG=−956 kJ/mol)
N₂ Formation Reaction: 4 NH₃+3 O₂→2 N₂+6 H₂O (ΔG=−1306 kJ/mol)
   Thus, a dual NO_{X}/NH₃ sensor is possible if one electrode material is catalytically selective to formation of N₂ via NH₃ oxidation, and a second electrode is catalytically selective to formation of NO_{X} via NH₃ oxidation.

The reason that the MgMoO₄ and MgWO₄ based electrodes (Examples 1 and 2) were additive and that the CoMoO₄ and CoWO₄ based electrodes (Examples 3 and 4) were selective was assessed via testing of these materials as ammonia oxidation catalysts. Samples for catalyst testing were prepared by calcining the electrode materials at 1000° C. (the temperature used for electrode annealing) and then sieving the calcined powders to a size range of 35 to 80 mesh. The materials were evaluated as catalysts for the NH₃ oxidation reaction with a gas hourly space velocity of 50,000 hr⁻¹ in simulated exhaust with a gas composition of (100 ppm NH₃, 5% O₂, 8% H₂O, 1 ppm SO₂, balance He).

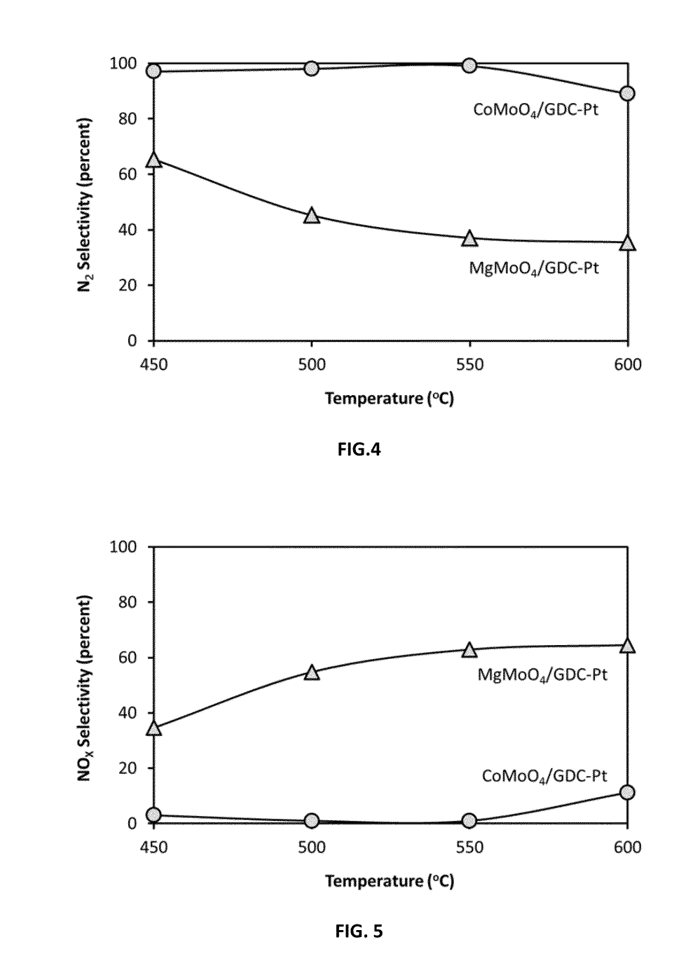

The NH₃ conversion, and nitrogen and NO_{X} selectivity were measured over the temperature range of 450 to 600° C. At all temperatures NH₃ conversion levels were greater than 98 percent, confirming that all four of these electrode materials function as ammonia oxidation catalysts. However, different selectivities (i.e., the percentage of nitrogen-containing products that are either N₂ or NO_{X}) were observed for the electrode materials. The data obtained at the nominal sensor operating temperature of 525° C. is summarized in Table 3, and FIGS. 4 and 5 compare the N₂ and NO_{X} selectivity for these two materials as a function of temperature.

TABLE 3
Ammonia oxidation catalyst testing results
for sensor electrode formulations (525° C.).

| | ABO₄ in | NH₃ | N₂ | NO_{X} |
|---|---|---|---|---|
| | Pt—ABO₄/ | Conversion | Selectivity | Selectivity |
| Example | GDC | (%) | (%) | (%) |
| 1 | MgMoO₄ | 98.5 | 41.1 | 58.9 |
| 2 | MgWO₄ | 98.3 | 48.6 | 51.4 |
| 3 | CoMoO₄ | 98.5 | 98.5 | 1.0 |
| 4 | CoWO₄ | 98.0 | 85.0 | 15.0 |

As demonstrated in Table 3 and FIGS. 4 and 5, the CoMoO₄ and CoWO₄ based electrode materials greatly favor the reaction pathway that results in conversion of NH₃ to N₂. Because the sensor is inert to N₂, when the NH₃ is converted to N₂ on the sensor surface, no change in sensor output will result. Conversely, the MgMoO₄ and MgWO₄ based electrode materials preferentially convert NH₃ to NO_{X}. Therefore, adsorption of NH₃ on the sensor surface results in an apparent increase in NO_{X} concentration, yielding a higher sensor output signal. Thus, by employing electrode materials with these two different reaction preferences, the NH₃ and NO_{X} levels can be differentiated.

Based on the above results, one scheme for a dual NO_{X}/NH₃ sensor is a two-electrochemical cell sensor, one with one active electrode comprising MgMoO₄ or MgWO₄ as the additive (total NO_{X}+NH₃) electrode, and the second with active electrode comprising CoMoO₄ or CoWO₄ as the selective (NO_{X} only) electrode. Any of the previously described active electrode compositions can be employed, such as three-phase composite mixtures of the molydate or tungstate compound, an electrolyte material (e.g., GDC or SDC), and a metal (e.g., platinum). In one particular embodiment, MgMoO₄/GDC-Pt or MgWO₄/GDC-Pt is the additive (total NO_{X}+NH₃) active electrode material, and CoMoO₄/GDC-Pt or CoWO₄/GDC-Pt is the selective (NO_{X} only) electrode material.

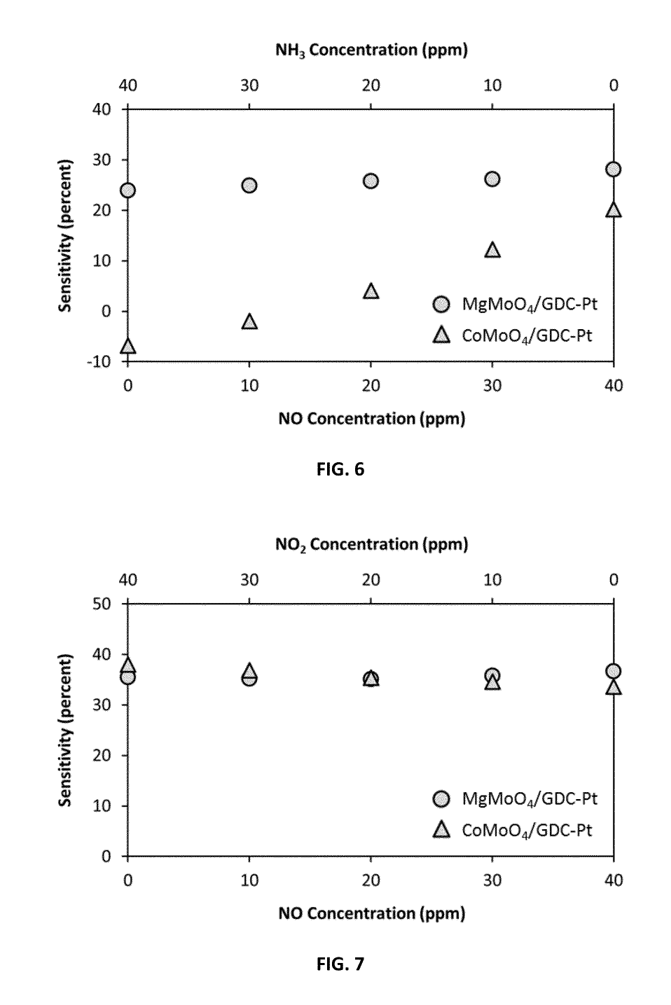

To further confirm the selective and additive performance, sensors of Example 1 (MgMoO₄/GDC-Pt active electrode) and Example 2 (CoMoO₄/GDC-Pt active electrode) were evaluated for dual NO_{X} and NH₃ sensitivity by the above described testing method. The data were collected by keeping the total concentration of NO and NH₃ at 40 ppm and varying the concentration of each species from 0 to 100 percent of the total. As shown in FIG. 6, the sensor of Example 1 (MgMoO₄/GDC-Pt active electrode) responded equivalently to each condition, while the sensor of Example 2 (CoMoO₄/GDC-Pt active electrode) only responded to the NO constituent of NO+NH₃ containing exhaust gas. A second set of experiments was performed using the same approach but substituting NO₂ for NH₃ in order to evaluate if there were any selectivity differences between NO and NO₂. As shown in FIG. 7, both sensors respond equivalently to each condition, thus confirming their additive nature with respect to NO and NO₂.

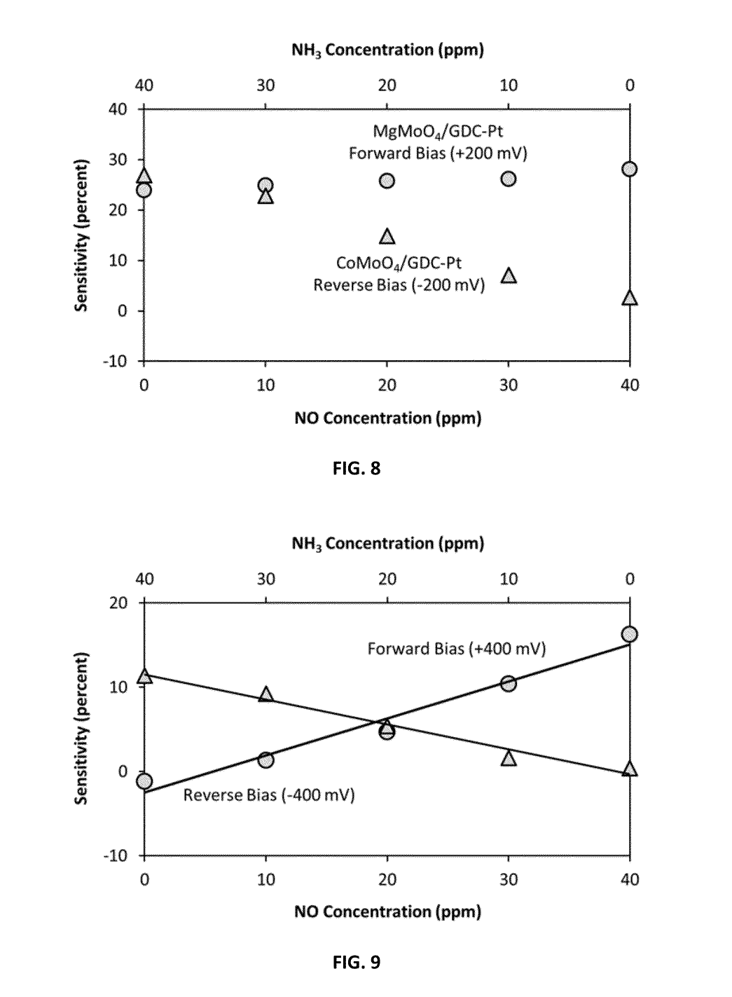

As discussed above, sensors made with CoMoO₄ and CoWO₄ based active electrodes are selective with respect to NO_{X} in the presence of NH₃. However, Applicants also have discovered that by reversing the polarity of the bias applied to a CoMoO₄ or CoWO₄ containing active electrode, the selectivity of the sensor switches from favoring NO_{X} to favoring NH₃. In this case, the ammonia oxidation to nitrogen reaction (with oxygen ions being pumped to the CoMoO₄ based electrode) is favored due to the low Gibbs free energy. This reaction is also supported strongly by La Chatelier's principle, since the oxygen ions are moving to this electrode and electrons are being removed to complete the circuit. Therefore, when biasing the electrode in the reverse direction, the response will be selective to NH₃. This approach was confirmed by testing (see FIG. 8). The sensor with the MgMoO₄ based active electrode responded equivalently to each of the NO_{X}+NH₃ conditions when biased in the normal (forward) direction, as was shown previously. When a reverse bias was applied to the CoMoO₄ based electrode, the sensor only responded to NH₃ (and not to NO_{X}).

As still another alternative embodiment, the change in selectivity of CoMoO₄ and CoWO₄ based active electrodes when the bias direction is reversed can be used advantageously to provide a dual NO_{X}/NH₃ sensor which uses two active electrodes of the same (or similar formulation), with different biasing of each electrode to obtain differentiation of NO_{X} and NH₃. This can be achieved with the CoMoO₄ or CoWO₄ based electrode material by switching the bias direction to manipulate the chemical reaction order to favor either the NO_{X} or NH₃ species, as described above. By operating two CoMoO₄ or CoWO₄ based active electrodes with opposing biases, the sensor is able to resolve both the content of NH₃ and NO_{X} by combining two selective sensors. This behavior was confirmed through sensor testing, and the results are shown in FIG. 9, with forward and reverse bias levels of 400 mV.

Based on the foregoing test results, a dual NO_{X}/NH₃ detecting sensor having two electrochemical cells can be readily fabricated. Such a sensor can comprise two physically separate electrochemical cells which together provide the dual NO_{X}/NH₃ sensor, or in one of the embodiments shown in FIGS. 10 and 11 described previously herein.

### Surface-Electrode Sensors for Dual NO_{X}/NH₃ Detection

As noted above, sensors comprising two electrochemical cells, with their respective active electrodes tailored to provide either additive (e.g., identical responses to NO, NO₂ and NH₃), or selective (e.g., identical responses to NO and NO₂ and a different response to NH₃) behaviors to target gas species can be fabricated, thus enabling detection of multiple target gas species (e.g., dual NO_{X}/NH₃ detection). Similarly, the inventors also have discovered that two electrochemical cells, one having an additive response to two or more target gas species, and one having a selective response to at least one of the target gas species, can be provided by tailoring the current collectors of the two cells in order to provide additive and selective sensor responses (e.g., to enable dual NO_{X}/NH₃ detection and quantification). This discovery was achieved by making devices where the current collector completely covers the surface of the active electrode (>about 90% coverage) and utilizing a device architecture where both the counter and active electrodes are deposited on the same surface of the electrolyte, in spaced-apart relationship. As demonstrated by testing reported further herein, the inventors have discovered that electrochemical sensing reactions become controlled by the current collector in this alternative arrangement. For example, in electrochemical cells having the same active electrodes (based on MgWO₄ or BaWO₄), additive sensor responses are achieved in cells incorporating a platinum based current collector over the active electrode and selective responses are achieved in cells incorporating a gold based current collector over the active electrode. This is made clearer by the following Examples.

Multiple sensor devices were made with the surface electrode architecture shown in FIG. 12. The common electrolyte layer (324) was GDC (as was described for all previous examples), and the active electrode (322), current collector (336) and counter-electrode (326) layers were varied (see Table 4). The sensors were tested with forward (positive) bias applied from the current collector (336) to the counter electrode (326) layers. The testing protocol was similar that described above for Examples 1-7; the sensors were tested with bias voltage of 200 mV at a temperature of 525° C. The baseline gas atmosphere consisted of 8 vol % CO₂, 5% vol % H₂O, 1 ppm SO₂, 10 vol % O₂, and 77 vol % N₂, sensor responses were observed for exposures to single-component analytes of 100 ppm NO, 100 ppm NO₂, or 100 ppm NH₃. Results are summarized in Table 5 and described in the paragraphs that follow.

TABLE 4
Compositions of component layers in
surface-electrode sensor Examples.

| Example | Active Electrode | Current Collector | Counter Electrode |
|---|---|---|---|
| 8 | Pt—MgWO₄/GDC | Au/GDC | Pt/ScSZ |
| 9 | Pt—MgWO₄/GDC | Pt/ScSZ | Pt/ScSZ |
| 10 | Pt—BaWO₄/GDC | Au/GDC | Pt/ScSZ |
| 11 | Pt—BaWO₄/GDC | Pt/ScSZ | Pt/ScSZ |
| 12 | MgWO₄/GDC | Pt/ScSZ | Pt/ScSZ |
| 13 | Pt—MgWO₄/GDC | Pt | Pt |
| 14 | Pt—MgWO₄/GDC | Au/GDC | Au/GDC |
| 15 | Pt—MgWO₄/GDC | Pt/ScSZ | Au/GDC |

TABLE 5
Sensing data for surface-electrode sensor Examples.

| | | Baseline | | | |
|---|---|---|---|---|---|
| | | Current | Sensitivity | Sensitivity | Sensitivity |
| | Bias | Signal | to 100 ppm | to 100 ppm | to 100 ppm |
| Example | (mV) | (μA) | NO | NO₂ | NH₃ |
| 8 | 200 | 8.90 | 33% | 43% | 2.5% |
| 9 | 200 | 6.53 | 39% | 31% | 33% |
| 10 | 200 | 5.41 | 91% | 108% | 49% |
| 11 | 200 | 3.81 | 167% | 160% | 164% |
| 12 | 200 | 0.85 | 21% | 13% | 21% |
| 13 | 200 | 0.140 | 5.7% | 7.1% | 1.4% |
| 14 | 200 | 9.44 | 23% | 45% | 30% |
| 15 | 200 | 4.72 | 95% | 108% | 181% |

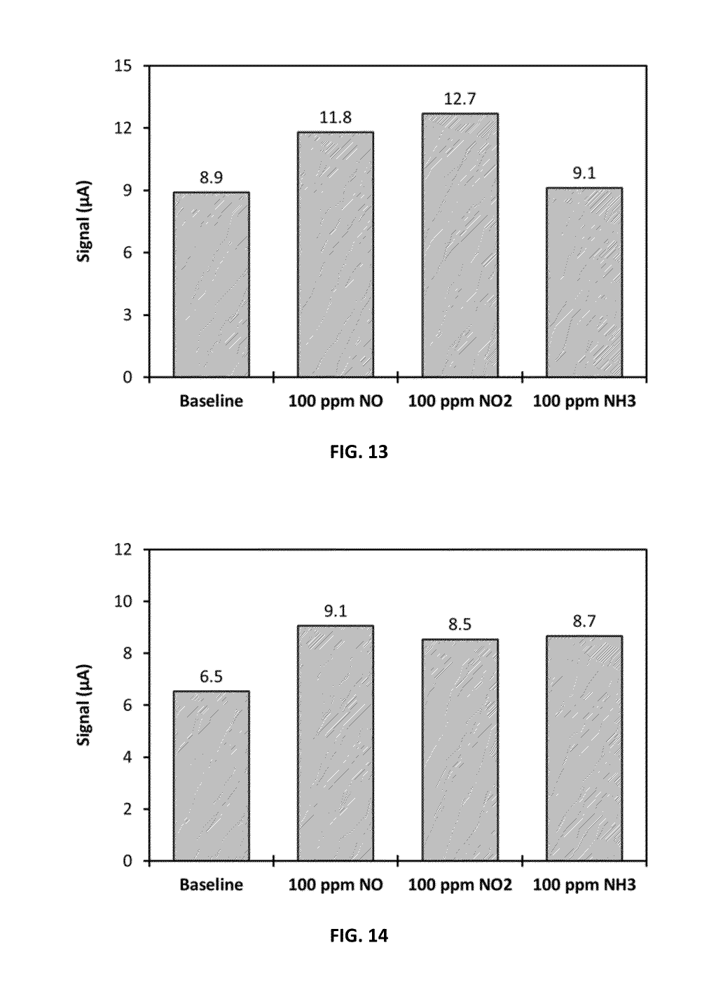

Test data obtained for the sensor of Example 8, with a Pt-MgWO₄/GDC active electrode, an Au/GDC current collector and a Pt/ScSZ counter electrode, are presented in Table 5 and FIG. 13. With a 200 mV bias applied at a temperature of 525° C., this sensor exhibited a baseline current signal of 8.9 μA, with selective sensing behavior (33 and 43 percent sensitivities to 100 ppm NO and 100 NO₂, respectively) and only 2 percent sensitivity to 100 ppm NH₃).

Test data obtained for the sensor of Example 9, with a Pt-MgWO₄/GDC active electrode, a Pt/SCSZ current collector and a Pt/ScSZ counter electrode, are presented in Table 5 and FIG. 14. With a 200 mV bias applied at a temperature of 525° C., this sensor exhibited a baseline current signal of 6.5 μA, with additive sensing behavior (39, 31 and 33 percent sensitivities to 100 ppm NO, 100 NO₂ and 100 ppm NH₃, respectively).

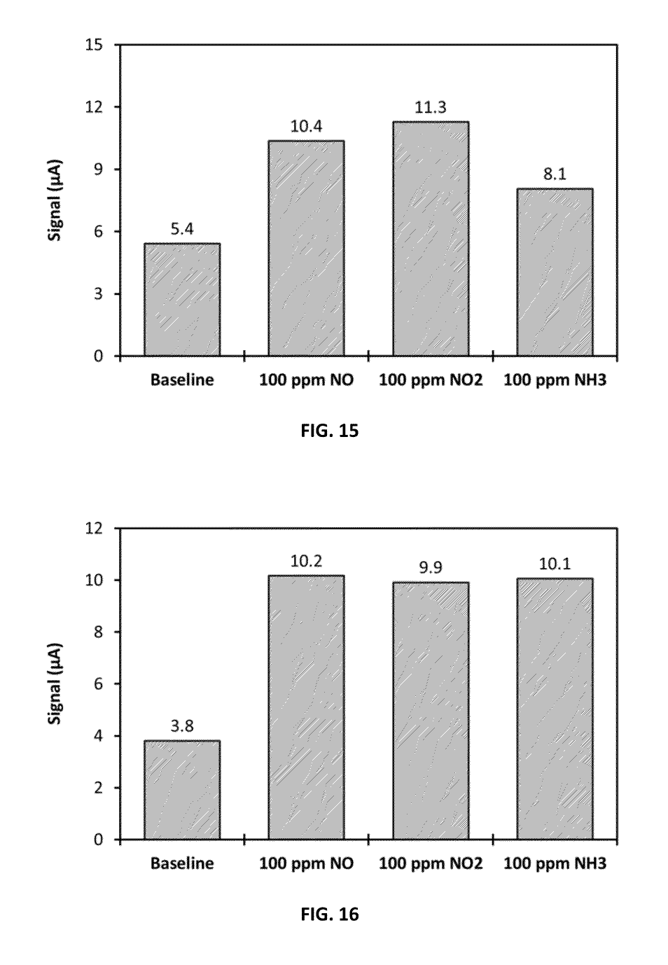

Test data obtained for the sensor of Example 10, with a Pt-BaWO₄/GDC active electrode, an Au/GDC current collector and Pt/ScSZ counter electrode, are presented in Table 5 and FIG. 15. With a 200 mV bias applied at a temperature of 525° C., this sensor exhibited a baseline current signal of 5.4 μA, with nominally selective sensing behavior (91 and 108 percent sensitivities to 100 ppm NO and 100 NO₂, respectively, and 49 percent sensitivity to 100 ppm NH₃). Thus, the replacement of MgWO₄ with BaWO₄ in the active electrode of this selective sensor led to a substantial increase in NO_{X} sensitivity, although a significant NH₃ response also was observed. For this sensor to be useful for selective NO_{X} detection, the NH₃ response would need to be reduced, perhaps by modifying thicknesses of the active electrode and current collector layers, or by changing the composition of the current collector layer.

Test data obtained for the sensor of Example 11, with a Pt-BaWO₄/GDC active electrode, a Pt/SCSZ current collector and a Pt/ScSZ counter electrode are presented in Table 5 and FIG. 16. With a 200 mV bias applied at a temperature of 525° C., this sensor exhibited a baseline current signal of 3.8 μA, with additive sensing behavior (167, 164 and 164 percent sensitivities to 100 ppm NO, 100 NO₂ and 100 ppm NH₃, respectively). Thus, the replacement of MgWO₄ with BaWO₄ in the active electrode of this additive sensor led to a four-fold increase in NO_{X} and NH₃ sensitivities.

Test data obtained for the sensor of Example 12, with a MgWO₄/GDC active electrode (without platinum in the active electrode), a Pt/SCSZ current collector and a Pt/ScSZ counter electrode, are presented in Table 5. With a 200 mV bias applied at a temperature of 525° C., this sensor exhibited a very low baseline current signal of 0.85 μA, with relatively low and non-perfectly additive sensitivities (21, 13 and 21 percent sensitivities to 100 ppm NO, 100 NO₂ and 100 ppm NH₃, respectively). These data exemplify the importance of including platinum in the active electrode in order to achieve desired NO_{X} and NH₃ sensing behavior.

Test data obtained for the sensor of Example 13, with a Pt-MgWO₄/GDC active electrode, a pure platinum current collector and a pure platinum counter electrode (without ScSZ or GDC in the current collector or counter electrodes), are presented in Table 5. With a 200 mV bias applied at a temperature of 525° C., this sensor exhibited drastically reduced baseline current signal of 0.14 μA, with very low sensitivities of 6, 7 and 1 percent sensitivities to 100 ppm NO, 100 NO₂ and 100 ppm NH₃, respectively. These data exemplify the importance of including electrolyte material (ScSZ or GDC) in the current collector and counter electrode layers.

Test data obtained for the sensor of Example 14, with a Pt-MgWO₄/GDC active electrode, an Au/GDC current collector and an Au/GDC counter electrode, are presented in Table 5. With a 200 mV bias applied at a temperature of 525° C., this sensor exhibited a relatively high baseline current signal of 9.4 μA, with 23, 45 and 30 percent sensitivities to 100 ppm NO, 100 NO₂ and 100 ppm NH₃, respectively. Thus, replacement of Pt/ScSZ with Au/GDC in the counter electrode resulted in a loss of selective behavior, confirming that platinum (and not gold) is preferred to be present in the counter electrode.

Test data obtained for the sensor of Example 15, with a Pt-MgWO₄/GDC active electrode, a Pt/ScSZ current collector and an Au/GDC counter electrode, are presented in Table 5. With a 200 mV bias applied at a temperature of 525° C., this sensor exhibited a baseline current signal of 4.7 μA, with 95, 108 and 181 percent sensitivities to 100 ppm NO, 100 NO₂ and 100 ppm NH₃, respectively. Thus, replacement of Pt/ScSZ with Au/GDC in the counter electrode resulted in a loss of additive behavior, again confirming that platinum (and not gold) is preferred to be present in the counter electrode.

As before, the above embodiments for dual NO_{X}/NH₃ detection with surface electrodes require a sensor having two electrochemical cells, either as two physically separate cells (e.g., two cells of the type shown in FIG. 12) or a single sensor made with two electrochemical cells formed on the surface of the sensor substrate. As discussed previously, there are multiple ways in which the electrochemical cells can be built in surface-electrode devices, as shown in FIGS. 17A-H. As described above, the two electrochemical cells having surface electrodes and different current collector layers can be configured so as to share a common substrate and, in some instances, a common electrolyte layer and/or a common counter electrode layer.

While several devices and components thereof have been discussed in detail above, it should be understood that the components, features, configurations, and methods of using the devices discussed are not limited to the contexts provided above. In particular, components, features, configurations, and methods of use described in the context of one of the devices may be incorporated into any of the other devices. Furthermore, not limited to the further description provided below, additional and alternative suitable components, features, configurations, and methods of using the devices, as well as various ways in which the teachings herein may be combined and interchanged, will be apparent to those of ordinary skill in the art in view of the teachings herein.

Having shown and described various versions in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. An amperometric electrochemical sensor for measuring the concentrations of two or more target gas species in a gas sample or gas stream, the sensor comprising first and second electrochemical cells having respective first and second active electrodes, said electrochemical cells further comprising an electrolyte membrane and a counter electrode, wherein the first electrochemical cell exhibits an additive response with respect to a first and second of said target gas species and the second electrochemical cell exhibits a selective response to the first target gas species in the presence of said second target gas species such that the sensor is capable of measuring the respective concentrations of said first and second target gas species.

2. The sensor of claim 1 wherein said first and second active electrodes each comprise at least one molybdate or tungstate compound.

3. The sensor of claim 2, wherein said at least one molybdate or tungstate compound comprises A_{X}(Mo_{(1-Z)}W_{Z}) _{Y}O_{(X+3Y)}, wherein X and Y are each independently selected integers from 1 to 5, 0≦Z≦1, and A is one or more of Mg, Zn, Ni, Co, Fe, Mn, Cu, Ca, Sr, Ba, and Pb.

4. The sensor of claim 3, wherein said first active electrode comprises MgMoO₄ or MgWO₄, and said second active electrode comprises CoMoO₄ or CoWO₄.

5. The sensor of claim 4, wherein at first and second active electrodes further comprise about 0.1% to 10%, by weight Pt, Pd, Rh, Ru, Ir, or alloys or mixtures of any of the foregoing metals.

6. The sensor of claim 1, wherein said first and second active electrodes comprise a composite mixture of: (a) at least one molybdate or tungstate compound; (b) at least one ceramic electrolyte material; and (c) at least one metal chosen from the group consisting of Pt, Pd, Rh, Ru, Ir, and alloys or mixtures of any of the foregoing.

7. The sensor of claim 6, wherein said first active electrode comprises a composite mixture of:
(a) MgMoO₄ or MgWO₄;
(b) an electrolyte chosen from the group consisting of GDC and SDC; and
(c) about 0.1% to 10% by weight of Pt, Pd, Rh, Ru, Ir, or alloys or mixtures of any of the foregoing metals.

8. The sensor of claim 7, wherein said second active electrode comprises a composite mixture of:
(a) CoMoO₄ or CoWO₄;
(b) an electrolyte chosen from the group consisting of GDC and SDC; and
(c) about 0.1% to 10% by weight of Pt, Pd, Rh, Ru, Ir, or alloys or mixtures of any of the foregoing metals.

9. The sensor of claim 1, wherein the active electrode of each electrochemical cell is located on the side of the electrolyte member opposite the counter electrode.

10. The sensor of claim 9, wherein said first and second electrochemical cells share at least one of a common electrolyte membrane and a common counter electrode.

11. The sensor of claim 1, wherein said first and second electrochemical cells further comprise respective first and second current collectors on said first and second active electrodes, respectively, wherein said first and second current collectors are adapted to provide said additive and selective responses.

12. The sensor of claim 11, wherein said first current collector comprises cermet of platinum and a ceramic electrolyte material, and said second current collector comprises cermet of gold and a ceramic electrolyte material.

13. The sensor of claim 12, wherein said first current collector comprises cermet of platinum and ScSz, and said second current collector comprises cermet of gold and GDC.

14. The sensor of claim 11, wherein the active electrode of each electrochemical cell is located on same side of the electrolyte member as the counter electrode.

15. The sensor of claim 14, wherein said first and second electrochemical cells share at least one of a common electrolyte membrane and a common counter electrode.

16. The sensor of claim 1, further comprising a substrate on which said counter electrode is located, the substrate chosen from the group consisting of: an insulating ceramic, a metal coated with an insulating material, and a cermet coated with an insulating material.

17. An amperometric electrochemical sensor for measuring the concentrations of two or more target gas species in a gas sample or gas stream, the sensor comprising first and second electrochemical cells having respective first and second active electrodes, wherein (a) the first active electrode exhibits an additive response with respect to a first and second of said target gas species, or a selective response to the first gas species in the presence of the second gas species when a first bias is applied to the first electrochemical cell, and (b) the second active electrode exhibits a selective response to the second gas species in the presence of the first gas species when a second bias of opposite polarity to the first is applied to the second electrochemical cell.

18. A method of detecting the concentrations of NO_{X} and NH₃ in a gas sample or stream, comprising the steps of:
(a) locating the sensor of claim 1 such that the electrochemical cells are exposed to the gas sample or stream;
(b) applying biases to the electrochemical cells;
(c) measuring the resulting currents through the sensor; and
(d) determining the concentration of NO_{X} and NH₃ based on the measured current.
